(19) United States
(12) Patent Application Publication
(10) Pub. No.: US 2015/0223632 A1
(43) Pub. Date: Aug. 13, 2015

(54) PORTABLE BEVERAGE CONTAINER

(71) Applicant: Joshua Hall, Escondido, CA (US)

(72) Inventor: Joshua Hall, Escondido, CA (US)

(21) Appl. No.: 14/618,401

(22) Filed: Feb. 10, 2015

Related U.S. Application Data
(63) Continuation-in-part of application No. 14/528,532, filed on Oct. 30, 2014.
(60) Provisional application No. 62/089,127, filed on Dec. 8, 2014.
(60) Provisional application No. 61/938,093, filed on Feb. 10, 2014.

(51) Int. Cl. A47J 31/44

(52) U.S. Cl. CPC A47J 31/44

(57) ABSTRACT

A cartridge for use with a drinking container having a fluid compartment, the cartridge having a concentrate compartment adapted for storage of a concentrate; a housing at least partially defining the concentrate compartment; a deformable wall coupled to the housing and at least partially defining the concentrate compartment; a valve coupled to the housing; and an air chamber separated from the concentrate compartment by the deformable wall. The cartridge is actuatable to inject sequential doses of the concentrate into a fluid compartment through the valve. Related systems, methods and devices are also described herein.

### CROSS-REFERENCE TO PRIORITY DOCUMENTS

This application claims priority of co-pending U.S. Provisional Application Ser. No. 61/938,093, filed Feb. 10, 2014; and U.S. Provisional Application Ser. No. 62/089,127, filed Dec. 8, 2014. This application is also a continuation-in-part of co-pending U.S. application Ser. No. 14/528,532, filed Oct. 30, 2014, which claims the benefit of priority of co-pending U.S. Provisional Application Ser. No. 61/938,093, filed Feb. 10, 2014. The full disclosures of each of the above-identified applications are hereby incorporated by reference in their entireties.

### BACKGROUND

Portable beverage containers exist in many forms that serve a broad range of purposes. These containers range from those that are intended to thermally insulate their contents, to easily-dispensed and robust containers intended for active use. The portable beverage containers that exist today also range in material composition, weight and dispensing mechanisms. There also exists heavy metal canteens with screw top lids for casual use, as well as light plastic containers with squirt-top lids intended for use while running, jogging or the like as well as for casual uses in the car, school lunches or when generally on-the-go.

The employment of portable beverage containers in the fitness world today has become popular since hydration is recognized as a critical component for maintaining energy during physical activity. Maintaining proper body hydration while performing physically demanding tasks is widely recognized as critical for maintaining energy as well as reducing the risk of cramping, loss of consciousness and confusion.

In recent years, dietary supplements and mixed drinks such as protein shakes and electrolyte supplements have become popular in the fitness community. These dietary supplements allow users to increase their protein and electrolyte intake before, during and after strenuous workouts, thereby allowing their body to accomplish more than possible when simply ingesting water. However, the introduction of many supplements to water in a portable beverage container creates further complications. Once a supplement is mixed with water, there is a limited time for ingesting it whereafter the supplement may not provide its intended results, or it may spoil entirely and be rendered inedible depending on varying environmental and storage conditions. Further, the container must be rinsed and cleaned soon thereafter or bacteria can grow and multiply using the rich food source onboard.

To prevent the spoiling and premature expiration of mixed supplement drinks, and to enhance the freshness of the mix, multi-compartment beverage containers exist, such as the container described in US 20130279287. This container allows a user to maintain separation of supplements and water in a single carry device without the need for bags or separate containment devices. However, during physical activity such as running or jogging, it can be very inconvenient to utilize this second compartment. The aforementioned device requires one to unscrew the bottom area where the supplement fluid or liquid is held, and manually deposit the mix into the main compartment housing the supply of water or other hydrating fluid.

US 20060113201 shows a valved, two compartment container. Shown is a beverage container possessing a one way valve to allow supplement fluid to pass from its compartment to the main compartment containing hydrating fluid. In order to pass the supplement fluid to mix into the hydrating container, the container must be held with one hand while a manual screw or dispensing mechanism must be activated with a second hand and requires the single mixing of all of the fluid with the supplement fluid.

This solution is undesired in many active settings where a two-handed activation or precision operation may be difficult to achieve and for some users, small mixing of fluid with supplement over time is desired rather a total mixing in a single action. Also, the one way mechanism described proves to be inadequate for powder supplements and mixers. This lack of powdered supplement accommodation proves to be unacceptable since the need to mix such supplements with a hydrating fluid while on the go in active environments is in great demand.

### SUMMARY

The present disclosure relates to methods, systems and devices to mix an onboard powder, solid, liquid or gel concentrate or other mixing material held in a chamber, with a contained fluid or water supply, to yield a fresh beverage mixture to the user.

In an implementation, disclosed is a cartridge for use with a drinking container having a fluid compartment. The cartridge includes a concentrate compartment adapted for storage of a concentrate; a housing at least partially defining the concentrate compartment; a deformable wall coupled to the housing and at least partially defining the concentrate compartment; a valve coupled to the housing; and an air chamber separated from the concentrate compartment by the deformable wall. The cartridge is actuatable to inject sequential doses of the concentrate into a fluid compartment through the valve.

The cartridge can further include the drinking container having the fluid compartment. The valve can be configured to provide fluid communication between the concentrate compartment and the fluid compartment of the drinking container when the cartridge is in use with the drinking container. The concentrate compartment can be configured as at least one of a disposable, single use cartridge or a refilled cartridge configured to allow insertion of an additional amount of concentrate. The cartridge can be configured to be partially disassembled such that the concentrate compartment can be refilled with the additional amount of concentrate. The deformable wall can be removably coupled to the housing. The deformable wall can be coupled to a lid configured to be removably coupled to the housing. The air chamber can be located within the removable lid. The deformable wall can be configured to store pressure energy. The deformable wall can aid in injecting the sequential doses of the concentrate through the valve. The deformable wall can be an elastic membrane formed of at least one of a polymer, a siloxane, or a silicone rubber. The deformable wall can include corrugations creating additional stored energy. The corrugations can be located near a perimeter of the deformable wall. Increased pressure within the fluid compartment can causes a volume of fluid from the fluid compartment to enter the concentrate compartment through the valve. The deformable wall can deflect towards the air chamber upon receipt of the volume of fluid from the fluid compartment. Upon removal of the increased pressure within the fluid compartment the deformable wall can return to its original position injecting a dose of the concentrate into the fluid compartment through the valve.

The concentrate compartment can have a volume sufficient to inject sequential doses sufficient to create a plurality of different mixed beverages. The plurality of mixed beverages can be 2, 3, 4, 5, or 6 different mixed beverages. The drinking container can include a lid removably coupled to a first end of the drinking container and a bottom removably coupled to a second end of the drinking container to sealingly contain the fluid compartment. The cartridge can be maintained in sealed engagement with the drinking container between the bottom and the second end of the drinking container upon threading the bottom onto the second end of the drinking container. The cartridge can further include an o-ring configured to form a fluid-tight seal between the bottom and the second end of the drinking container. The cartridge can include a flange around a perimeter configured to be captured between the o-ring and the second end of the drinking container such that the deformable wall extends across a recess of the removable bottom. The air chamber can be located within the recess of the removable bottom. The cartridge can be integrated with the removable bottom of the drinking container. The valve can be positioned within an aperture extending through a portion of the housing.

The deformable wall can be located opposite the valve. At least a portion of the fluid compartment of the drinking container can be flexible. Compression of the portion of the fluid compartment can cause fluid contained within the fluid compartment to enter the concentrate compartment through the valve. Release of the compression can inject a dose of the concentrate from the concentrate compartment through the valve and into the fluid compartment. The drinking container can include one or more pressure pads positioned within one or more windows through a wall of the drinking container. The wall of the drinking container can be formed of a rigid material. Compression on the one or more pressure pads can cause metered fluid contained within the fluid compartment to enter the concentrate compartment through the valve. The one or more pressure pads can be divided into a plurality of separately actuatable buttons. Each of the buttons can be configured to dispense a dose of the concentrate into the fluid compartment upon actuation. The fluid compartment of the drinking container can be rigid. The deformable wall of the cartridge can be available through an aperture in a wall of the drinking container such that the deformable wall is manually compressible during use. A potency chart can be configured to be positioned on an outer surface of the drinking container. The potency chart can include a plurality of color gradations for comparison with a color of the mixed beverage within the fluid compartment after one or more of the sequential doses is injected into the fluid compartment. The air chamber and the deformable wall can be coupled to a removable cap configured to be reversibly sealed onto the housing. The removable cap can be configured to be removed from the housing while the cartridge is installed in the drinking container. The removable cap can extend external to a bottom end of the drinking container. The drinking container can include a foot engaged on the bottom end of the drinking container that extends beyond the removable cap creating an even standing surface. The deformable wall can form an elastic inner wall of the cartridge and the housing can form a rigid outer wall of the cartridge and the air chamber is formed between the inner and outer walls. The deformable wall and the air chamber can form an internal air bladder configured to be compressed upon squeezing a wall of the drinking container within which the cartridge is contained such that fluid from the fluid compartment is received within the concentrate compartment. The concentrate can be a liquid or gel and wherein the valve can be a pressure-actuated dual-flow valve, a two-way valve, or a dripless two-way valve. The cartridge can be single use and disposable. The cartridge can be prepackaged with the concentrate contained within the concentrate compartment. The cartridge can be refillable and resealable.

In an interrelated aspect, disclosed is a beverage mixing system having a drinking container and a cartridge. The drinking container includes a fluid compartment surrounded at least in part by an inner wall; the inner wall comprising a deformable membrane; an outer wall surrounding at least in part the inner wall forming an air chamber therebetween; and a check valve in fluid communication with the air chamber. The cartridge is removably coupled to the drinking container and includes a housing configured to be coupled to the drinking container and at least partially defining a concentrate compartment adapted for storage of a concentrate. The concentrate compartment is separated from the air chamber by the check valve. The cartridge includes a valve coupled to the housing and configured to provide fluid communication between the concentrate compartment and the fluid compartment of the drinking container when the cartridge is in use with the drinking container. The cartridge is actuatable to inject sequential doses of the concentrate into the fluid compartment through the valve.

In an interrelated aspect, disclosed is a beverage mixing system including a drinking container and a cartridge. The drinking container includes a fluid compartment; and an air chamber. The cartridge is removably coupled to the drinking container and includes a rigid housing portion at least partially defining a concentrate compartment adapted for storage of a concentrate; a flexible housing portion coupled to the rigid housing portion at least partially defining the concentrate compartment; and a valve coupled to the rigid housing portion. When the cartridge is in use with the drinking container, the valve is configured to provide fluid communication between the concentrate compartment and the fluid compartment of the drinking container and the flexible housing portion is positioned within the air chamber and configured to expand. The cartridge is actuatable to inject sequential doses of the concentrate into the fluid compartment through the valve.

In an interrelated aspect, disclosed is a cartridge for use with a drinking container having a fluid compartment. The cartridge includes a concentrate compartment adapted for storage of a concentrate; a housing at least partially defining the concentrate compartment; a deformable wall coupled to the housing and at least partially defining the concentrate compartment; and a window in the housing configured to provide fluid communication between the concentrate compartment and a fluid compartment of a drinking container when the cartridge is in use with the drinking container. The cartridge is actuatable to open the window allowing mixing between the concentrate and a fluid in the fluid compartment through the window.

The window can be a partially perforated region in the housing configured to break away relative to a surrounding region of the housing upon application of pressure from outside the cartridge. The window can be an opening covered by a material configured to give way relative to the housing upon application of pressure from outside the cartridge. The concentrate compartment can be separated into two or more compartments. Each of the two or more compartments can have a window that is separately actuatable. The concentrate can be a powder or a solid.

In an interrelated aspect, disclosed is a beverage mixing system including a drinking container and a cartridge removably coupled to the drinking container. The drinking container includes a rigid inner wall forming an open fluid compartment; an outer wall surrounding the inner wall at least a portion of which is elastic; and an air chamber positioned between the inner and outer walls. The cartridge includes a concentrate compartment adapted for storage of a concentrate; a housing at least partially defining the concentrate compartment; a deformable wall coupled to the housing and having an upper surface at least partially defining the concentrate compartment and a lower surface in fluid communication with the air chamber; a valve coupled to the housing and configured to provide fluid communication between the concentrate compartment and the fluid compartment of the drinking container when the cartridge is in use with the drinking container; and a sealing element configured to be reversibly coupled with the outer wall of the drinking container creating a fluid-tight seal when the cartridge is in use with the drinking container. The cartridge is actuatable by squeezing the portion of the outer wall that is elastic to inject sequential doses of the concentrate into the fluid compartment through the valve.

The system can further include a spacer positioned between the sealing element and the lower surface of the deformable wall. The spacer can include an open architecture allowing fluid communication between the air chamber and the deformable wall.

In an interrelated aspect, disclosed is a mixing container including a housing having a first compartment therein adapted for storage of a fluid. The first compartment is in operative communication with a second compartment. The second compartment is configured for holding a supply of concentrate for mixing with said fluid. The first compartment is compressible to thereby temporarily increase a pressure therein from a first pressure level to an increased pressure level within said first compartment, during compressions thereof. The mixing container has a valve providing fluid communication between said first compartment and said second compartment. The valve has a first position preventing said fluid communication. The valve has a second position allowing said fluid communication between said first compartment and said second compartment in a directional flow to the one of said first compartment and said second compartment having a highest said pressure level therein, to the other having a lower said pressure level therein. A mixing of said fluid with said concentrate to successively higher concentrations within said fluid in said first compartment, is actuatable by sequential said compressions and release of said compressions of said first compartment.

The second compartment can be a removably engageable cartridge and the cartridge can have a cartridge housing defining said second compartment therein. The mixing container can further include said second compartment having at least one elastic wall; and said elastic wall expanding during each said contraction of said first compartment; said elastic wall contracting subsequent to cessation of each said contraction; and said contracting of said elastic wall inducing a higher pressure in said second compartment upon cessation of said compressions of said first compartment and a pressurized flow of said fluid from said second compartment through said valve toward said first compartment. The mixing container can additionally include said cartridge housing having at least one elastic wall area; and said elastic wall area expanding during each said elastic wall expanding during each said contraction of said first compartment; said elastic wall contracting subsequent to cessation of each said contraction; and said contracting of said elastic wall inducing a higher pressure in said second compartment upon cessation of said compressions of said first compartment and a pressurized flow of said fluid from said second compartment through said valve toward said first compartment. The mixing container can additionally include said valve being operatively engaged to said cartridge housing whereby said valve is replaceable by a replacement of said cartridge. The valve can be operatively engaged to said cartridge housing whereby said valve is replaceable by a replacement of said cartridge. The mixing container can additionally include said cartridge positionable within a complimentary shaped cavity to that of a shape of said cartridge, at a lower housing removably engageable with said housing. The mixing container can additionally include said cartridge positionable within a complimentary shaped cavity to that of a shape of said cartridge, at a lower housing removably engageable with said housing. The mixing container can additionally include said cartridge positionable within a complimentary shaped cavity to that of a shape of said cartridge, at a lower housing removably engageable with said housing.

In an interrelated aspect, disclosed is a mixing container including a first housing having a first compartment therein adapted for storage of a fluid; said first compartment communicable with a second compartment, said second compartment configured for holding a supply of concentrate for mixing with said fluid; said first compartment being sealable and compressible to thereby temporarily increase a pressure therein from a first pressure level, to an increased pressure level within said first compartment, during compressions thereof; a valve providing fluid communication between said first compartment and said second compartment; said valve having a first position preventing said fluid communication; said valve having a second position allowing said fluid communication between said first compartment and said second compartment in a directional flow; said valve moving permanently to said second position, upon a said increased pressure level within said first compartment; and whereby a mixing of said fluid with said concentrate is actuated by a compression of said first compartment.

The mixing container can additionally include said second compartment being a removably engageable cartridge, said cartridge having a cartridge housing defining said second compartment therein. The mixing container can additionally include said cartridge positionable within a complimentary shaped cavity to that of a shape of said cartridge, at a lower housing engageable with said first housing.

In an interrelated aspect, disclosed is a method of using a device or system of any of the preceding claims to make a mixed beverage.

In an interrelated aspect, disclosed is a method of making a mixed beverage including actuating delivery of a dose of concentrate into a fluid compartment of a drinking container having a cartridge removably coupled to the drinking container. The cartridge includes a housing at least partially defining a concentrate compartment adapted for storage of the concentrate; a deformable wall coupled to the housing and at least partially defining the concentrate compartment; a valve coupled to the housing and configured to provide fluid communication between the concentrate compartment and the fluid compartment of the drinking container; and an air chamber separated from the concentrate compartment by the deformable wall. The method includes increasing a pressure within the fluid compartment of the drinking container. The fluid compartment contains a fluid. The method includes receiving an amount of the fluid from the fluid compartment by the concentrate compartment through the valve; deflecting at least a portion of the deformable wall away from the concentrate compartment toward the air chamber to increase a volume of the concentrate compartment; and returning the at least a portion of the deformable wall towards the concentrate compartment to inject an amount of the concentrate through the valve into the fluid compartment to mix with a remaining amount of the fluid in the fluid compartment.

Returning can include elastically returning to a memory shape. The deformable wall can be configured to store pressure energy. The deformable wall can be an elastic membrane formed of at least one of a polymer, a siloxane, or a silicone rubber. Increasing a pressure can include squeezing a flexible outer wall of the drinking container. Increasing a pressure can include actuating one or more pressure pads on a wall of the drinking container. The method can further include metering the increased pressure using the one or more pressure pads. The method can further include releasing the flexible outer wall of the drinking container allowing the at least a portion of the deformable wall to return towards the concentrate compartment. The method can further include at least partially disassembling the cartridge to open the concentrate compartment. The method can further include filling the concentrate compartment with additional concentrate and resealing the concentrate compartment upon reassembly. The method can further include injecting sequential doses of the concentrate into the fluid compartment through the valve. The concentrate can be a liquid or gel and the valve can be a pressure-actuated dual-flow valve, a two-way valve, or a dripless two-way valve.

The above-noted aspects and features may be implemented in systems, apparatus, and/or methods, depending on the desired configuration. The details of one or more variations of the subject matter described herein are set forth in the accompanying drawings and the description below. Features and advantages of the subject matter described herein will be apparent from the description and drawings, and from the claims.

### BRIEF DESCRIPTION OF DRAWING FIGURES

FIG. 1 depicts a perspective view of the device depicting a liquid such as water in a first compartment and a solute mix such as powder or syrup in a second compartment, separated by a valve mechanism configured to seal a communication aperture.

FIG. 2 is a perspective view of the device illustrating the mixing of the solute from the second compartment and liquid from the first compartment, caused by a temporary opening of the valve mechanism caused by the squeezing of the flexible walls surrounding the liquid compartment.

FIG. 3 depicts a perspective view of the device with the solute and liquids removed after it has been impacted upon a surface, thereby inverting the valve-spring mechanism and fully opening the valve until it is reset manually.

FIG. 4 depicts a perspective view of the device with a different type of inverting spring used in the valve mechanism that incorporates an amalgamating structure.

FIG. 5 depicts a perspective exploded view of an example of the device illustrating the mating and removable component properties.

FIG. 6 shows a particularly preferred mode of the device having a second compartment which is engageable to the device and later disposable, and employs a cartridge-positioned pressure activated dual flow valve mechanism to provide communication of fluid between the second compartment and first.

FIG. 6a depicts an example of a pressure actuated dual flow valve showing the closed and flow-actuated positions allowing mixing of concentrate in the second compartment with fluid in the first compartment.

FIG. 7 shows a mode of the device having another mode of engageable cartridge providing a disposable second compartment shown in the form of a cup like structure for purposes of illustration only, and could be any shape or dimension.

FIG. 8 depicts a mode of the device wherein the engageable cartridge has a pressure-openable or liquid-openable seal which communicates into the lower end of the fluid reservoir of a closeable container housing.

FIG. 9 shows the device of FIG. 8 wherein pressure from squeezing the sidewalls, or communication with the fluid, has opened the foil or aperture cover of the cartridge such that the concentrate within the cartridge mixes with the fluid.

FIG. 10 depicts the device employing an open end fluid vessel such as a glass or large cup, and showing the open cartridge aperture caused by fluid communication therewith, or using pressure from squeezing the flexible sidewalls with an engageable lid attached to the open end.

FIG. 11 shows an exploded view of an implementation of a container configured to receive a cartridge.

FIG. 12 shows a perspective view of a removable bottom for use with a container.

FIGS. 13A-13B show perspective top and bottom views, respectfully, of a cartridge.

FIGS. 13C-13D show top and cross-sectional side views, respectfully, of a cartridge.

FIG. 14 shows an interrelated implementation of a cartridge configured to be used with a drinking container.

FIG. 15 shows an interrelated implementation of a cartridge configured to be used with a drinking container.

FIG. 16 shows an interrelated implementation of a cartridge configured to be used with an open drinking container.

FIG. 17 shows an interrelated implementation of a cartridge configured to be used with a drinking container.

FIG. 18 shows an interrelated implementation of a cartridge configured to be used with a drinking container.

FIG. 19 shows an interrelated implementation of a cartridge configured to be used with a drinking container.

FIGS. 20A and 20B show an interrelated implementation of a cartridge for use with a rigid walled drinking container.

FIG. 21 shows an interrelated implementation of a cartridge for use with a rigid walled drinking container.

FIG. 22 shows an interrelated implementation of a cartridge for use with a drinking container having one or more pressure pads.

FIG. 23 shows an interrelated implementation of a cartridge for use with a drinking container having a potency chart.

FIG. 24 shows an interrelated implementation of a cartridge configured to be used with a drinking container.

FIGS. 25 and 26 show interrelated implementations of a cartridge having a break-away window configured to be used with a drinking container.

### DETAILED DESCRIPTION

There is a continual and unmet need for an improved device and system for storage of fluid and a supplement or other reservoir of fluid-enhancing mix. Described herein are devices formed of easily-engaged components capable of housing a mix such as a concentrate fluid or powder in a portable beverage container also having a reservoir of fluid such as water. Described herein are devices that allow the mixing of fluids, powders or both to create flavored water, punch, coffee, tea, meal replacements, protein drinks, etc., for example, in a one-handed operation, to accommodate on-the-go uses as well as extreme environmental and active circumstances of use. Described herein are devices that allow a user a mode of operation allowing for an incremental partial mixing of the water supply with onboard fluids or powders to a complete dilution. Such a partial mixing over time can allow ongoing sequential activations to increase or decrease the flavoring or supplement mixed with the water or other liquid stored in the reservoir side of the container. Described herein are devices and methods that allow for the easy cleaning and more preferably, easy replacement of onboard compartments, and especially valves therebetween, such as with replaceable cartridges, to maintain the container free of bacteria and odors.

Described are beverage containers configured to mix an onboard powder, solid, gel or liquid concentrate held in a second chamber, with a contained fluid or water supply, to yield a fresh beverage mixture to the user. The devices employing compartments separated by a valve mechanism provides for a separation of water or liquid from the concentrate flavoring or supplement which allows for a user-controlled mixing of liquid upon either a squeezing or the imparting of an impact to the device. The devices can employ permanent secondary compartments or employ replaceable concentrated cartridges.

The devices and methods herein disclosed and described achieves the above-mentioned goals through the provision of a multi-compartment, portable beverage container with a compression or pressure activated mechanism for mixing of the fluid in a first compartment with a supplement or flavoring stored in a second compartment which may be permanent or in a preferable mode, is a replaceable cartridge. The pressure imparted by the single hand of a user to the first compartment can provide a way for mixing the liquid with the stored concentrate, supplement, or flavoring held in the second compartment or cartridge providing a second compartment.

In some implementations, a spring-like or reversible flow valve mechanism and seal separates the compartments housing a fluid or water supply, from a concentrate or a mixture supply for dilution in the fluid supply. The valve mechanism can respond to pressure to direct the flow of fluid between the compartments and provide a pressure actuated mechanism for mixing. In some implementations, the second container is formed as a cartridge which is removably engageable with the housing of the device. The cartridge is formed of polymeric material which is removably engageable in sealed communication with the fluid supply in the first compartment when installed to the housing of the device. The cartridge mode of the device allows the user to have a plurality of such engageable containers of supplements or flavorings or other mixtures which can be removably engaged for mixing the onboard concentrate with the fluid or water supply in the first compartment. The cartridges can be available in a wide variety of supplements and flavor concentrates and the like, and can be engaged by the user according to their anticipated use of the device.

In some implementations, the devices include a housing having a main fluid containment area or compartment adapted to hold a supply of water or another liquid desired for mixing with the supplement or flavoring or other concentrate stored in a second compartment which is selectively communicable with the fluid in the first compartment. In use, the fluid in the first compartment may be placed in total, or in incremental communication with a removable solute or mixture in the second compartment or cartridge. Communication of fluid between the first compartment and the second compartment is activated by a user compression of the first compartment hosting the fluid to induce a fluid flow to and between the two compartments.

The pressure-induced fluid flow may be controlled by a dampened spring-like valve mechanism and which may also operate as an optional amalgamating membrane or webbing. Alternately, the mechanism for pressure induced fluid flow may be implemented using compression and resulting pressure to the fluid retainment area, to communicate fluid to a supply or reservoir of flavoring or supplements or the like in the second compartment through a pressure actuated bidirectional valve. The fluid communicated to the second compartment returns to the fluid supply of the first compartment mixed with concentrate or supplements or flavoring or the like, by inverse pressure actuating the valve mechanism to reverse fluid flow. This can occur by either a suction or negative pressure is generated in the first compartment when compression thereof ceases, or in addition, the second compartment is configured to elastically store the pressure therein and thereby have a higher pressure than the first compartment upon cessation of compression thereof.

The device in use may be employed to transport a liquid such as water in the first compartment and a solute or concentrate such as a protein powder supplement or a syrup for flavoring or other fluid-soluble mixture in the separate second compartment. This maintains the fluid and mix separate prior to use and fresh in both respective compartments prior to a communication of some or all of the water supply with the compartment containing the supplement.

Subsequent to a user-induced mixing of fluid between the two valve-separated compartments, the water or fluid may be consumed during or after strenuous physical activity or as needed. The device in a particularly favored mode is cylindrical in shape for easy gripping, compression, and retainment in the hand of a user. In order to insure proper cleaning, each of the two compartments of the housing is preferably separable for cleaning thereof and cleaning any valve mechanism positioned therebetween. Using the cartridge for a second compartment it is preferable that the valve be engaged in the wall of the cartridge and thus replaced with each use. It should be appreciated that the devices described herein can be used at any time and is not limited to fluids consumed during or after strenuous physical activity. For example, the devices described herein can be used whenever a user feels like consuming a mixed beverage.

The liquid such as water held in the first compartment is engageable in an operative communication with a mechanism for dispensing the fluid or water, which can be positioned at a first end thereof. The mechanism can include a sealable opening or valve allowing ingestion by the user when moved to an open position. Sidewalls of the compartment are preferably sufficiently flexible such that they can be compressed between the thumb and fingers of a user. Opposite the drinking or dispensing end of the first compartment, the valve mechanism component can be situated to provide a sealed bi-directional communication of the fluid in the first compartment and the mix or concentrate in the second compartment.

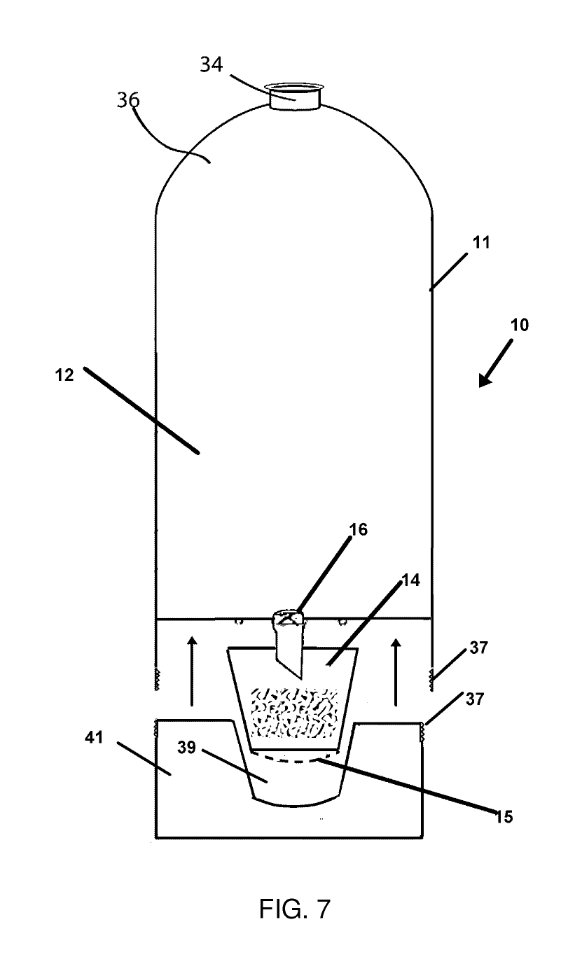

The valve mechanism separates fluid communication from the first or main compartment holding the liquid supply, with the smaller second or solute compartment housing a powder or syrup or concentrate or the like which is adapted to dissolve in the water or liquid communicated from the first compartment. The valve mechanism may either mate with both the first and second compartments, or in some modes it may be formed partially or entirely into housing of the second compartment and operatively mate with the first compartment. As noted the second compartment may be removably engageable to allow for the employment of sealed containers or cartridges such as cup-like structure (as depicted at for example FIG. 7) to be employed by the user, and the placement of the valve in the cartridge is preferred to allow replacement thereof with each use.

The valve mechanism can be pressure actuated such that compressing the area of the first compartment housing the fluid such as water, will cause a pressured communication of a portion of the fluid into the second compartment. Upon cessation of the communication of pressure to the first compartment by the user, fluid communicated to the second compartment mixed with concentrate or flavoring or the like, can be substantially returned from the second compartment, through the valve, to mix with the remaining fluid in the first compartment.

In some implementations, the pressure actuated valve mechanism employs a dampened spring-like system with two modes of operation. In operation, a squeezing of the sidewalls of the first compartment of the device will impart pressure to the first compartment. This pressure will force the valve to temporarily open when there is positive pressure acting on its surface from the first or main solvent compartment. Cessation of pressure stops fluid communication to the second compartment and a return thereof to the first compartment. This action allows for multiple sequential partial mixing with the solute compartment through the valve. A dampening mechanism of the spring-like valve mode of the device prevents the valve from immediately shutting when the pressure is released, or when the compressive means is removed from the first compartment hosting the liquid supply. The dampening effect and slight time delay of closure of the valve, may be created by the presence of a closed-cell foam, gasket, or elastic air cushion between the spring mechanism and the valve's resting planar surface. The spring-like component of the pressure actuated valve mechanism can also be configured to allow for a second operating mode. In this mode if a significant biasing force or pressure, over a threshold force, acts upon the valve's surface, a spring or biasing means urging the valve closed, will translate and will lock in the open position. This positioning maintains a continuous communication between fluid in the first compartment and mix in the second compartment. Such a biasing force may be created by impacting the housing on a surface at the distal end, opposite the dispensing end. The impact force from the contact communicates the fluid in the liquid compartment against the surface of the valve surface, thereby overcoming a threshold bias level holding it closed, and rendering it fully open passed its locking, or inversion point.

This translation of the pressure actuated valve toward the second compartment and the end of the device impacting a surface, which locks open the valve allows, opens a communication and allows for complete continuous mixing of the two compartments. The valve translates toward the distal end to remain open due to an arced annular wall of material forming a spring or bias of the valve closure toward the first compartment which must be overcome by pressure, or a force above a threshold level. The spring in this annular arch is configured such that when sufficient force is imparted to translated the annular section a distance toward the second compartment, the arced wall forming the biasing force will invert and lock the valve in the open position. When the valve is locked open, the mixing of the liquid and solute may be facilitated by shaking the device and thereby forcing the solution to pass through an optional amalgamating membrane or webbing that may be attached to the valve. In some embodiments, the membrane or webbing may act as the spring in the valve mechanism and may be hemispherical or dome-like. A hemispherical or dome-like webbing or polymer material may also operate with the same principles as an inverting flat spring, as the flexible webbing may invert as well. The amalgamating membrane or webbing may also be an optional clip-in component. The spring-like component may be formed of stainless steel, spring steel, plastic, or similar materials. The valve-mechanism component is centrally located and has mating surfaces such as complimentary threaded surfaces on both ends. However, they may be formed in such a way that the mechanism can be removed and the solute and liquid compartments may be attached to each other.

In other implementations, the pressure actuated valve component can be formed of flexible polymeric material to cause a pressure-directed communication of liquid from the first compartment to be mixed with the mixture stored in the second compartment when the first compartment is compressed. Pressure imparted to the fluid supply from compression of the sealed first compartment causes fluid to communicate through the pressure actuated valve into the second compartment. Cessation of compression of the first compartment causes the pressure therein to return to normal whereafter the fluid communicated to the second compartment which stores the pressure by flexing or stretching is returned having been mixed with the contents of the second compartment. The return of fluid from the second compartment to the first is caused by a suction generated in the collapsed first compartment upon cessation of compression and a stored pressure in the second compartment if formed to do so. A deformable wall of the second compartment which is elastic, contracts to an un-stretched position thereby imparting pressure into the second compartment causing communication of fluid therein from the first compartment, to return through a valved channel to the first compartment. This mode allows for the incremental mixing of the fluid from the first compartment to the second, and incremental returning of fluid to the supply in the first compartment. Thus, the user can impart more or less mixture from the second compartment to the first, depending on the number of times the first compartment is compressed to cause the mixing and return of fluid to the first compartment from the second.

The solute, supplement or concentrate holding second compartment may be formed of the same material as the liquid compartment but may be smaller in volume. The second or solute compartment if exposed, or the housing of the device, may also have a removable padded base that mates with the surface opposite the valve mechanism mating surface to protect it during impact valve operation. As noted, there may also be a lid for the first compartment, or it may be a sealed removable component thereby enabling it to be used separately from the device, or used interchangeably with multiple vessels and devices.

In some implementations, the compressible first compartment when pressurized by compression of the walls of the first compartment, will actuate the pressure actuated valve component to cause a flow of fluid into the second compartment. Thereafter, when pressure upon the first compartment ceases, stored pressure in the second compartment will reverse the flow through the valve component and communicate the mixed fluid back to the first compartment. Thus the valve component has a first position wherein substantially all fluid communication in either direction is prevented. Further it has a second position wherein the valve component opens to allow fluid flow in the direction from higher pressure to a lower pressure compartment until pressure equalizes and the valve component moves again to the first position.

It is to be understood that the described devices and methods are not limited in their application to the details of construction and to the arrangement of the components in the following description or illustrated in the drawings. The described devices and methods are capable of other embodiments and of being practiced and carried out in various ways. Also, it is to be understood that the phraseology and terminology employed herein are for the purpose of description and should not be regarded as limiting.

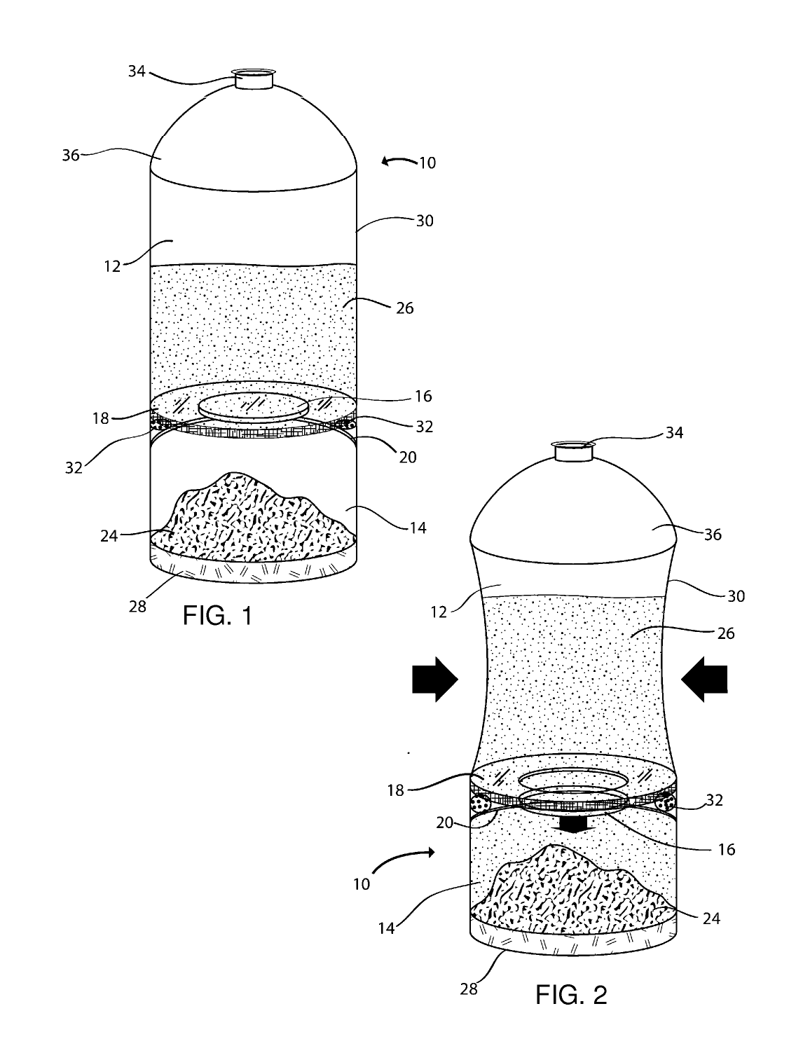

Referring now to the drawings, the device 10 can be employed for the transport, containment, mixing and dispensing or drinking of a mixed-beverage of the liquid housed in a first compartment 12 of the container 11 and the mixture housed in a second compartment 14. FIG. 1 depicts an implementation of a device 10 that includes a first or liquid compartment 12 in operative engagement with a solute or second compartment 14. A communicating pathway therebetween is separated by a valve 16 to prevent the premature mixing of each compartment's respective contents.

The valve 16 is shown seated within a resting structure 18 in a closed state blocking communication between the first and second compartment, and supported by an inverting spring 20. The inverting spring shown may be made of stainless steel, spring steel, or plastic in various forms. The inverting spring 20 may also be replaced by various shapes and forms as shown in FIG. 4 where it takes on the form of an inverting and amalgamating dome spring mechanism 22 to accomplish other goals such as the improved mixing of solutes 24 and liquids 26.

The inverting spring 20 shown in FIGS. 1, 2, 3 and 5 enables the liquid compartment 12 to remain isolated from the solute compartment 14 until a time of desired mixing. The valve 16 may translate away from an aperture communicating with the first compartment 12 to fully and instantly open communication between both compartments, through an impact of the padded base 28 upon a surface.

The valve 16 can be activated incrementally, and opened and sealed sequentially, by the squeezing and compressing of the first compartment walls 30 as shown in FIG. 2. Such compression causes a temporary pressurization increase in the first compartment 12 and opens the valve mechanism to allow a short duration of mixing of the fluid in the first compartment 12, with the mixture in the second compartment, allowing the user to determine the amount of mixture which is communicated back into the liquid in the first compartment 12 to make a stronger or weaker mix. This allows the device to be refilled once the original supply of fluid in the first compartment 12 has been consumed, and the process repeated in this sequential short mixing mode. In other modes the valve 16 may be included in an insertable cartridges 17 defining the second cavity 14 and would be replaced with each new cartridge 17 inserted.

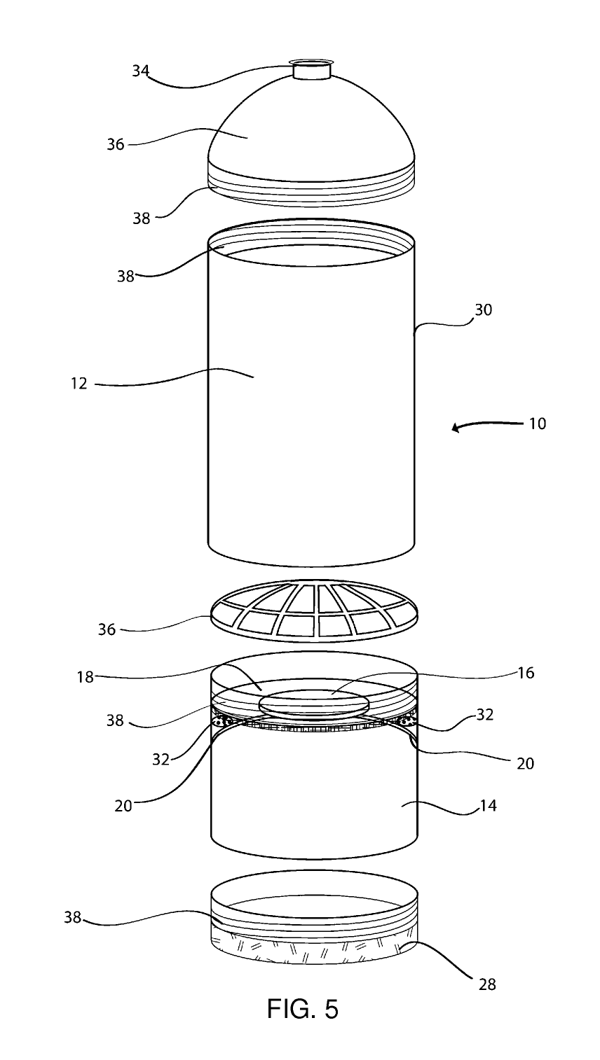

In the valve mechanism of FIGS. 1,2, 3 and 5 there is also illustrated a dampening component 32 located between the inverting spring 20 and the valve's resting structure 18. The dampening component 32 in FIGS. 1 and 5 appear compressed relative to other figures due to the valve 16 being closed and the corresponding inverting spring 20 pressing the dampening component 32 against the valve's resting structure 18.

This dampening component 32 slows the closing and sealing action of the valve 16 after the liquid compartment walls 30 have been compressed and the valve 16 has been actuated as shown in FIG. 2. Shown in FIG. 2 is the dampening component 32 no longer compressed due to the increase in separation between the inverting flat spring 20 and the valve's resting structure 18. The compression or contraction of the dampening component 32 when the walls 30 are squeezed to impart pressure into the device, enables a slowed closing by providing a resistance bias to the inverting flat spring 20 as the dampening component 32 compresses, while also allowing a small amount of fluid which was squeezed through from the solute compartment, to return.

The dampening and slow-closing action and expansion of the dampening component once compression to the sidewalls ceases, enables the device 10 as noted to “burp,” or sequentially mix small portions of the liquid 26 with small portions of solute 24. This “burping” or temporary mixing is shown in FIG. 2 and enables the user to obtain small amounts of the solute 24 in the liquid 26, which is desirable with concentrated additives. As noted, this action also enables a user to mix small amounts and consume them, and subsequently refill the liquid compartment 12 multiple times with an easily accessible fluid such as water before needing to replenish the solute 24 while still enjoying the solute flavors or supplement benefits.

The device 10 is shown with a dispensing nozzle 34 affixed to the domed peak of a removable lid 36. This nozzle should be formed in such a way that an opening due to internal pressure will not occur during a compressive biasing of the compartment walls 30.

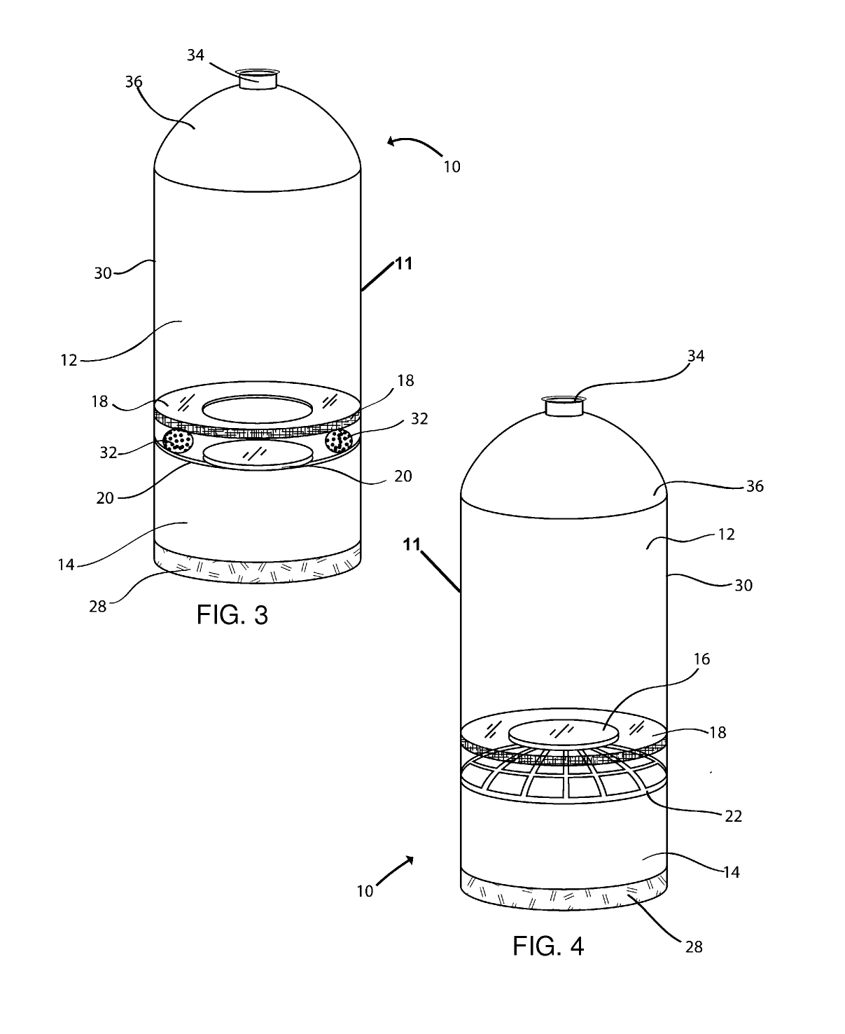

FIG. 3 depicts the device 10 where the inverting spring 20 is inverted and the valve 16 mechanism is thereby locked open. This open-valve mode occurs after the base 28 has impacted a solid surface, thereby transferring the kinetic energy of the device through the liquid 26 and against the surface of the valve 16. That transfer of energy applies a significant biasing which is relational to the surface area of the valve 16 and overcomes the biasing force of the spring forcing the valve 16 to an open position. As expected in this mode, the dampening component 32 does not appear to be compressed as this is the maximum space allowable between the inverting flat spring 20 and the valve's resting structure 18. In this mode, the solute 24 and liquid 26 mix into a solution and become the desired mixed beverage that is ready for consumption.

Shown in FIG. 4 is the device 10 with a replacement component for the inverting spring 20. In this embodiment, an inverting and amalgamating dome-spring mechanism 22 is present to provide resistance biasing to the valve 16 toward sealing the first chamber from the second, as well as facilitate the mixing of solutes 24 and liquids 26 upon impact and translation of the spring. In this embodiment, the dampening component 32 mentioned previously is not shown, but may take on the form of an air cushion-donut or ring-like gasket due to the shape of the inverting and amalgamating dome-spring mechanism 22. Also, the space between the webbing of the inverting and amalgamating dome-spring mechanism 22 allows fluid solutions to pass through while creating turbulence during device 10 shaking, thereby assisting in the amalgamation of the solute 24 and liquid 26. This action helps to prevent dry chunks from remaining in the solution when a powdered solute 24 is used.

If the amalgamating properties of the inverting and amalgamating dome-spring mechanism 22 are only sometimes desired, an embodiment shown in FIG. 5 illustrates a removable amalgamating webbing 36 that may clip into the device 10. This amalgamating webbing 36 may be used in conjunction with the more simple inverting flat spring 20, and should accomplish the same mixing functions as the inverting and amalgamating dome-spring mechanism 22.

FIG. 5 also depicts the device 10 with all components separated in an exploded view. This illustrates that different components may be mated through the employment of complimentary threaded surfaces 38, and the components should be interchangeable. This interchangeability enables a user to omit the valve 16 and solute compartment 14 by attaching the padded base 28 directly to the liquid or first compartment 12. It also shows that the solute housing second compartment 14 can be treated as an individual container if a mating lid is attached to its complimentary threaded surface. Padded base 28 components may act as a mating lid in this circumstance. This enables a user to carry multiple solute compartments 14 with different solutes 24 for attachment to a single liquid compartment 12.

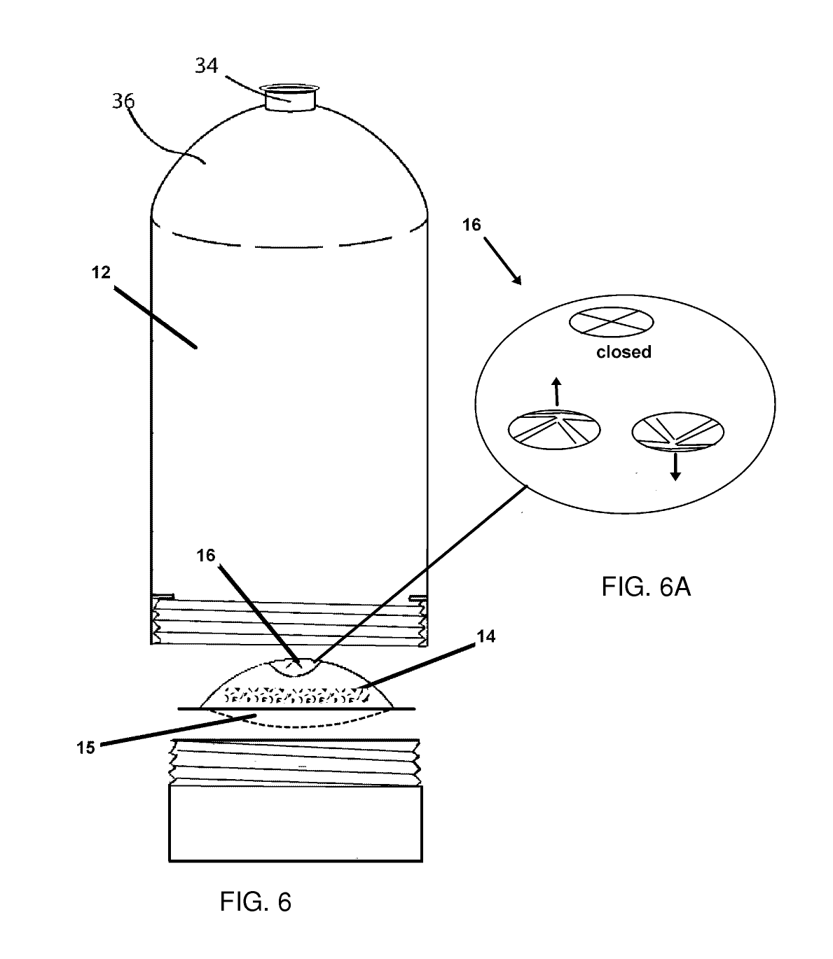

FIG. 6 an implementation of the device 10, having a second compartment 14 formed by a cartridge, which is removably engageable to the device 10. The cartridge can be later disposed and/or refilled. In some implementations, users can buy the mixture (e.g. liquid flavor concentrate, vitamins, coffee, tea, punch, etc.) prepackaged in the cartridge forming the second compartment 14 which would be provided sealed therein and will allow for commercial sales in stores and for instance in vending machines. The cartridges can be sold or dispensed having onboard valves 16 engaged to the cartridge defining the sealed second compartments 14, and may have any of a plurality of different mixes housed therein for different purposes when mixed with the liquid of the first compartment 12. Upon finishing use of the mixture in the cartridge defining second compartment 14, it may be disposed and replaced with another. Of particular note is that having the valve 16 engaged with the cartridge allows for replacement of the valve 16 with each cartridge change. Of course the second compartment 14 if formed of an engageable cartridge, might also be refilled and resealed. It should be appreciated that one cartridge may be swapped out and replaced with a different cartridge prior to the contents of that one cartridge being exhausted. For example, if a user desires a different flavoring or a different type of mixed beverage, cartridges may be swapped out at any time during use. Also, the cartridges described herein can be refilled and reused as described in more detail below.

As shown, the pressure activated valve mechanism 16 in this mode employs a pressure activated dual flow valve 16 mechanism to provide communication of fluid between the second compartment 14 and first compartment 12. The valve 16 engaged between the first and second compartment 14 is pressure activated to open and allow flow in either direction, but toward the compartment with lowest pressure until such is normalized. In this mode when force is imparted to the first compartment 12, fluid is forced into the removable second compartment 14 or cartridge. Upon cessation of compression of the first compartment 12, suction is generated by the collapsed walls returning to a normal position which helps cause the return of fluid mixed with concentrate in the second compartment 14 to the first compartment 12. Stored pressure can also be employed to induce the reverse flow from the second compartment 14 to the first in combination with the suction formed therein.

As shown, a deformable wall 15 of the second compartment or cartridge may be elastic and employed to store pressure energy. Once pressure from the first compartment 12 ceases, and suction forms in the first compartment 12, the wall 15 contracts to an un-stretched position thereby imparting higher pressure into the second compartment 14 than the first, thereby causing communication of fluid therein to the first compartment 12 through the valve 16 mechanism. In this removable and replaceable cartridge mode of the second compartment 14, the valve 16 is continually replaced and helps avoid contamination from food or material which may become lodged in the valve 16.

While it should be in no way considered limiting, shown in FIG. 6a is an example of a pressure-actuated dual-flow valve 16. While any such valve which substantially ceases communication between two compartments when pressure in both are substantially equal can be employed, the example in FIG. 6a shows the operation of such simple and inexpensive valves. In some implementations, the dual-flow valve 16 can be a SIMPLISQUEEZE silicone valve (Aptargroup, Inc.) or valves described in U.S. Pat. No. 5,839,614. It should be appreciated that the devices described herein can have any of a variety of valves including, but not limited to a dual-flow valve.

The valve 16 has a first position shown as the closed mode where flaps formed by slits in a flexible plastic or polymeric sheet are substantially in contact with each other along perimeter edges. In first position or the closed mode, fluid communication is substantially prevented between the two compartments on either side of the valve 16. Also shown is a second position of the valve 16 allowing flow from the compartment with the highest pressure, toward the compartment with the lower pressure which as shown can be in either direction depending on the relative pressure differential between the two compartments.

The valve 16 in the mode of the device 10 with permanent first and second compartments may be engaged therebetween. In the preferred mode of the device 10 employing replaceable cartridges for the second compartment 14, the valve 16 may be engaged with the cartridge to allow the user to renew the valve 16 with each new cartridge which will be a significant improvement over current devices where internal valves can become contaminated with grime and germs and bacteria if left unwashed after use.

By substantially prevented is meant that none or minor amounts, such as fractions of a milliliter, will communicate across the closed valve 16. The other two modes of the valve 16 show fluid flowing away from the valve in a direction away from the compartment with the higher pressure. Such will occur when the bottle is compressed to communicate fluid past the valve into the second compartment 14 or disposable cartridge.

This flow will reverse when compression of the first compartment ceases, causing a suction to develop from the walls moving to the uncompressed position and dropping pressure, and pressure in the second compartment 14 or cartridge becoming higher, due to elastic walls of the disposable cartridge, or a flexible membrane in the second compartment 14 storing the pressure energy which rebounds upon cessation of compression of the first compartment. In this fashion a pressure actuated dual flow valve 16 providing the valve mechanism between the compartments, allows the fluid under higher pressure from the first compartment to mix with concentrate in the disposable cartridge or second compartment 14, and return the mixture to the fluid in the first compartment upon cessation of compression thereof which lowers the pressure in the first compartment lower than that of the second compartment 14.

Any pressure actuated dual flow valve 16 can be employed to regulate the flow in the container 11 between the first compartment and second compartment 14, to allow more or less concentrate from a cartridge or second compartment 14 to be mixed with the fluid in the first compartment. As such, any such valve which will provide flow in-between the two compartments in a direction from higher pressure to lower pressure, and substantially eliminate such fluid communication when pressure between the two compartments is equal.

There is seen in FIG. 7 a mode of the device 10 having another configuration of a container 11 having a replaceable and disposable second compartment 14 such as an engageable cartridge 17 as shown in FIGS. 7-10. As depicted for illustration purposes only, and in no manner limiting on dimensions or shape of the engageable second compartment 14, there is shown a cup like structure having dimensional configuration of a cartridge 17 which may be formed with elastic walls, which will be easily manufactured due to widespread use of such a configuration for coffee makers and the like. This mode may include the valve mechanism 16 such as in FIG. 6 if the body of the second compartment 14 is elastic in nature. Or, it may be configured to engage with a one way valve as shown, or with a valve 16 system positioned in an aperture in the cartridge itself which opens in reaction to fluid communication for a time duration, or pressure generated by compressing the sidewalls, or both.

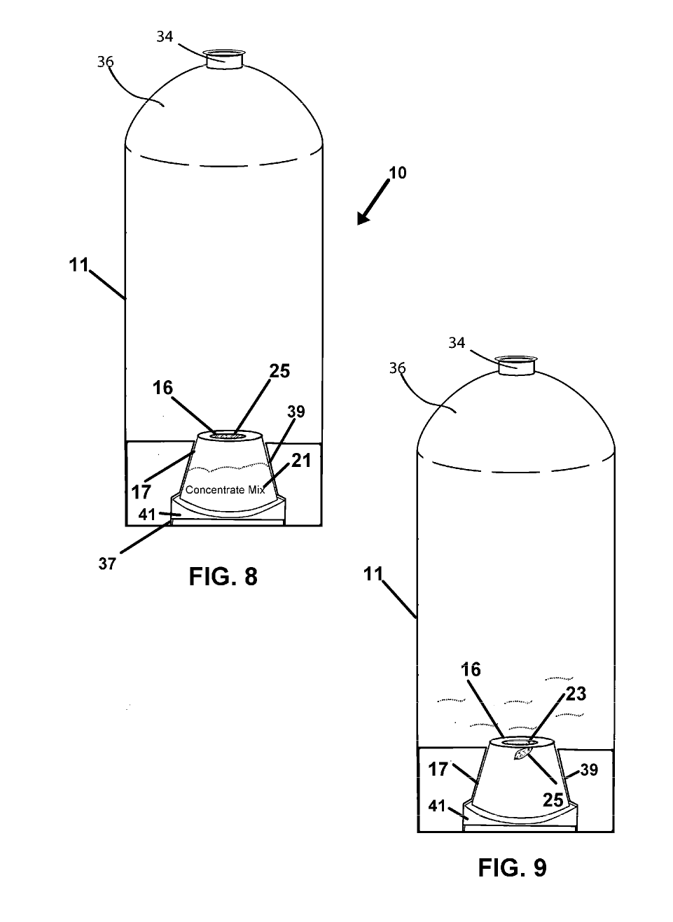

As shown in FIG. 8, the container 11 of the device 10 can employ cartridges 17 to provide an engageable second compartment 14 of the device 10 wherein the engageable cartridge 17 defining the second compartment 14 has a pressure-openable or liquid-openable seal engaged around an aperture 23 providing the valve 16. The aperture end of the cartridge 17 is positionable into the lower end of the first compartment 12 defining the fluid reservoir of a closeable container 11 housing. In this mode of the device 10, squeezing the flexible sidewalls will communicate pressure to the first compartment 12 and against the seal 16 in the cartridge 17 mode of the second compartment 14 such that it will either peel pack in its adhesive engagement, or rupture, or otherwise allow communication of fluid freely between both the first compartment 12 and the second compartment defined by the cartridge 17.

FIG. 9 shows the device of FIG. 8 wherein pressure from squeezing the sidewalls, or communication with the fluid for a duration of time, has caused an opining between the body of the cartridge 17 and foil or aperture cover forming the valve 16 of the cartridge 17 defining the second compartment 14, such that the concentrate 21 within the cartridge 17 defining the second compartment 14, freely mixes with the fluid from the first compartment 12 through an open aperture 23. Where a cartridge 17 is employed as the second compartment 14, it is engaged operatively through a passage, and/or positionable in a complimentary dimensioned cavity 39 within a removably engageable lower housing 41 or the like, to hold it in place until the valve 16 formed in the end wall of the cartridge 17 is ruptured, separated, or otherwise opened by one or a combination of pressure in the first compartment 12 or fluid communication which dissolves adhesive holding the closure 25 sealed over the aperture 23 in the cartridge 17 sidewall.

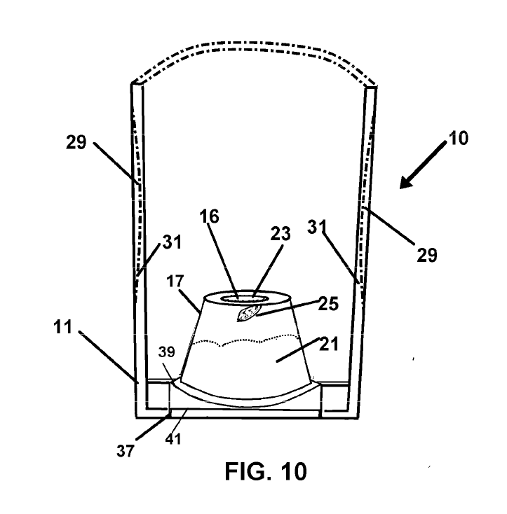

FIG. 10 depicts the device 10 employing an open end fluid container 11 such as a glass or large cup, and showing the opened cartridge 17 aperture 23, caused by fluid communication therewith and/or pressure against the closure 25 of the aperture 23 from squeezing the flexible sidewalls forming the first compartment 12 of the container 11 with an engageable lid (not shown) attached to the edge at the open end. A complimentary cavity 39 is formed to accept and seal against the edge of the cartridge 17 to hold it in place as earlier shown and described. Deformable walls 26 can be formed in the sidewalls of the container 11 by positioning an air cavity 31 therein. Alternatively, the valve 16 from FIGS. 6 and 8, may also be employed within the aperture 23 as with other modes of the device 10 herein using the closure 25, when a permanent opening is not desirable with continuous mixing, and where sequential mixing of fluid and concentrate based on compression of the first compartment is desirable to allow the user a means to increase or decrease the mix of concentrate 21 with the fluid based on the number of compressions.

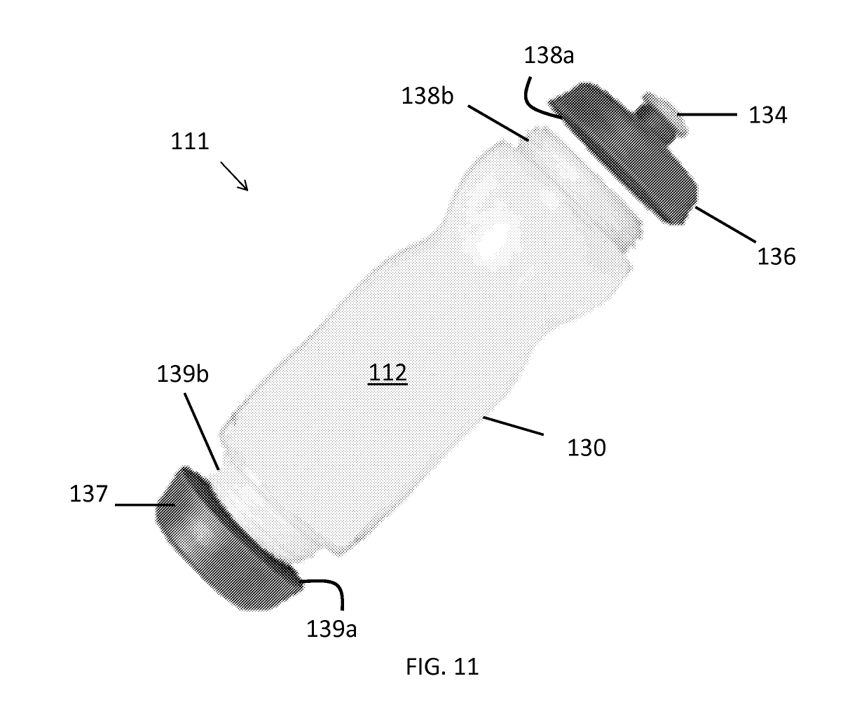

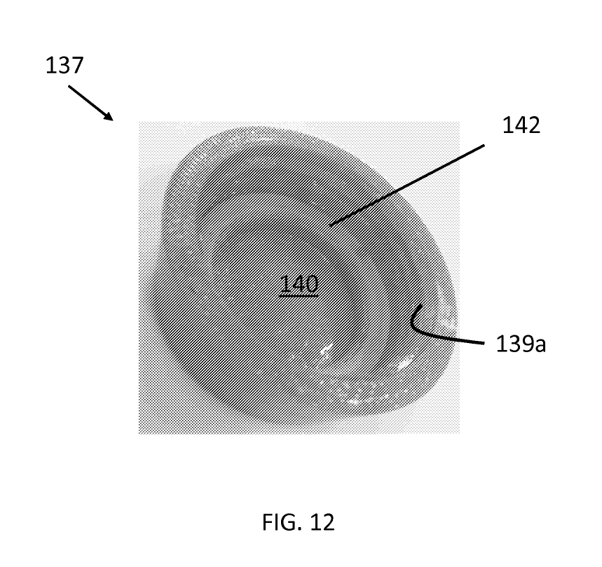

FIGS. 11, 12, and 13A-13D show an interrelated implementation of the device. FIG. 11 is an exploded, perspective view of a container 111 having a removable lid 136 and a removable bottom 137. The container 111 is configured to receive and be removably engaged with an insertable cartridge 117, which will be described in more detail below. The removable lid 136 can include a dispensing nozzle 134 and have threads 138a complementary to threads 138b on a top end region of the container 111. The removable bottom 137 (also shown in FIG. 12) can have threads 139a complementary to threads 139b on a bottom end region of the container 111. The removable lid 136 and the removable bottom 137 can be threaded onto the container 111 to contain a liquid therein. It should be appreciated that use of the terms “top” and “bottom” are used for reference only and are not intended to be limiting.

The removable bottom 137, shown in greater detail in FIG. 12, can have a recess 140 configured to receive the insertable cartridge 117. A terminal end region of the removable bottom 137 can include a step configured to have an o-ring 142 or other sealing element positioned resting thereon such that upon threading the removable bottom 137 onto the bottom end region of the container 111 the o-ring 142 abuts the bottom of the container 111 and a fluid-tight seal is formed between the removable bottom 137 and the container 111. Similarly, an o-ring or other sealing element can be positioned within the removable lid 136 such that a seal is formed between the removable lid 136 and the container 111.

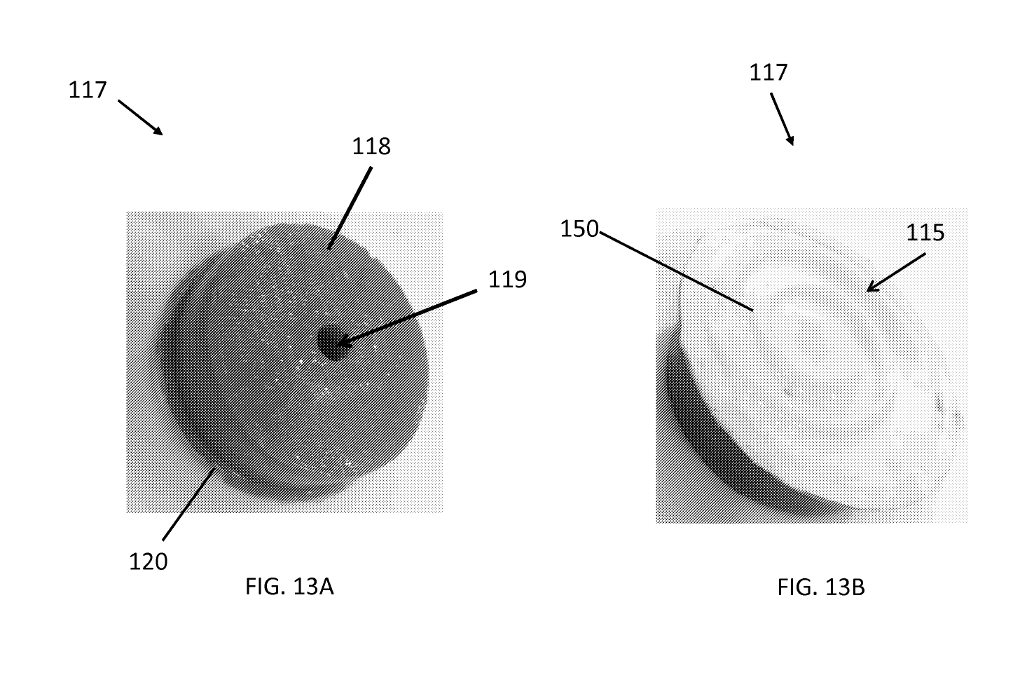

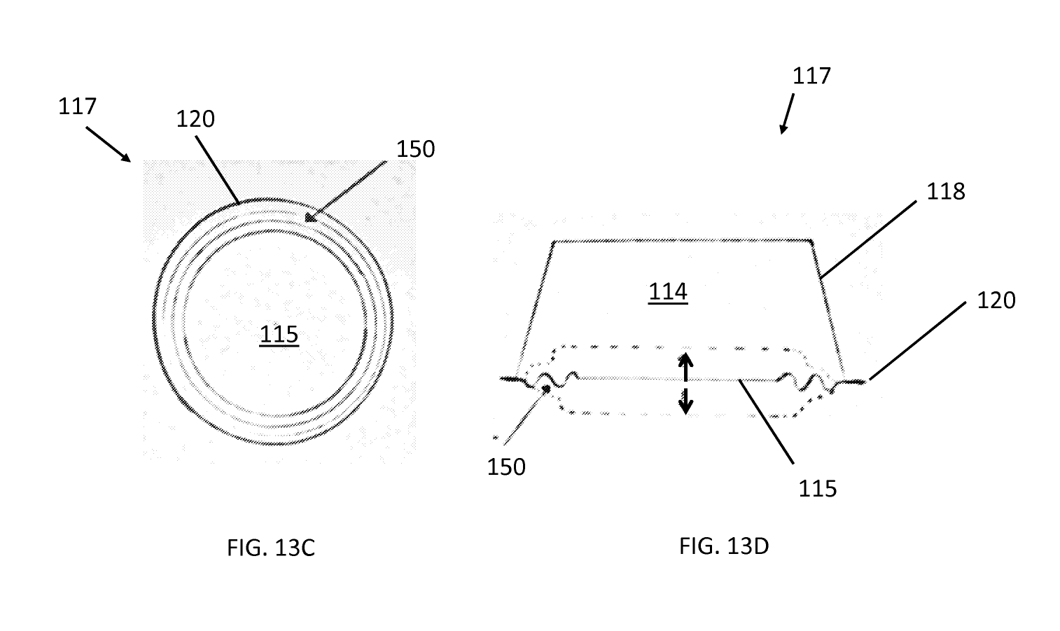

Implementations of an insertable cartridge 117 are shown in FIGS. 13A-13D. The cartridge 117 can have a housing 118 within which an amount of a material can be contained. A first wall of the housing 118 can have an aperture 119 (see FIG. 13A) extending through it that is configured to retain a valve, such as the valve 16 shown in FIG. 6a as well as other types of valves. A second wall (or portion of a second wall) of the housing 118 can be a deformable wall 115 (see FIG. 13B). The deformable wall 115 of the second compartment or cartridge may be elastic and employed to store pressure energy. The deformable wall 115 can be located opposite the first wall of the housing 118 retaining the valve 16 such that the second compartment 114 extends therebetween (see FIG. 13D). The deformable wall 115 can be surrounded by a flange 120 or other larger diameter element. As mentioned above, the cartridge 117 can be sized and shape to be received within the recess 140 of the removable bottom 137. When positioned within the removable bottom 137, the flange 120 abuts the o-ring 142 and the deformable wall 115 extends across the recess 140. The remainder of the housing 118 including the first wall retaining the valve 16 can also be sized and shaped to be received at least in part within the bottom end region of the container 111. In some implementations, the bottom end region of the container 111 can be cylindrical and at least a portion of the housing 118 can be cylindrical and have an outer diameter that is sized to fit within an inner diameter of the bottom end region of the container 111 such that the valve 16 is capable of being in fluid communication with the second compartment 112. The flange 120 or other larger diameter element can be sized to abut the bottom end of the container 111 preventing the entire cartridge 117 from being received within the second compartment 112 of the container 111. Upon screwing the removable bottom 137 onto the bottom end region of the container 111, the flange 120 can be captured between the bottom of the container 111 and the o-ring 142 positioned within the removable bottom 137. The valve 16 extends towards the second compartment 112 and the deformable wall 115 is separated from the valve 16 by the second compartment 114 near the o-ring end of the removable cap 137.

It should be appreciated that the three-dimensional shape of the housing 118 can vary and is not limited to what is shown in these drawings. For example, the three-dimensional shape of the housing 118 can include, but is not limited to cylindrical, dome, pyramidal, polygonal or other three-dimensional shape.

The cartridge 117 can be a disposable element that can be prepackaged with a mixture contained within the second compartment 114. The cartridge 117 can be manufactured and/or sold separately from the container 111. The mixture can be a liquid mixture that can be mixed with a liquid contained within the first compartment 112, as will be described in more detail below. Upon finishing use of the mixture in the cartridge 117, the cartridge 117 can be disposed and replaced by another cartridge 117. It should be appreciated that the cartridge 117 can also be a refillable and resealable cartridge that need not be disposed after use as described in more detail below.

The valve mechanism 16 can be a pressure-activated valve such as a pressure activated dual-flow valve as described herein. The valve 16 can provide fluid communication between the first compartment 112 and the second compartment 114. The valve 16 can be positioned between the first and second compartments 112, 114 and activated to open and allow fluid flow in either direction upon opening such as by pressure differential across the valve 16, as described in more detail below and as described above.

The removable lid 136 can be securely threaded onto the top end region of the container 111 and the removable bottom 137 can be securely threaded onto the bottom end region of the container 111 such that the flange 120 of the cartridge 117 is captured between the bottom of the container 111 and the o-ring 142 and the valve 16 of the cartridge 117 is placed in fluid communication with the first compartment 112. The first compartment 112 can be formed by walls 130, the removable lid 136 and at least a portion of the housing 118 of the cartridge 117 and fluidly separated from the second compartment 114 by the valve 16. The first compartment 112 is a fixed-volume chamber (assuming no leaks) having a flexible wall (wall 130) and the second compartment 114 is also a fixed-volume chamber having a flexible wall (deformable wall 115). A first volume of liquid can be contained within the first compartment 112 and a second volume of liquid can be contained within the second compartment 114. The pressure differential across the valve 16 is under the cracking pressure of the valve 16 such that the valve 16 remains closed and the two volumes of liquid are maintained separated from one another until mixing of the liquids is desired.

In an implementation, when mixing of the liquids is desired, a user may squeeze the flexible wall 130 of the container 111. Compression of the flexible wall 130 of the first compartment 112 results in an increased pressure within the first compartment 112 and creates a pressure differential across the valve 16. When cracking pressure is reached, the valve 16 opens towards the second compartment 114 having the lower pressure. Liquid contained within the first compartment 112 is forced to enter the second compartment 114 such that it can mix with liquid in the second compartment 114. Liquid from the first compartment 112 can be further injected into the second compartment 114 as the walls 130 of the container 111 are further compressed. The volume of liquid capable of being received by the second compartment 114 can depend on the overall size of the cartridge 117, the resiliency of the deformable wall 115 as well as how much compression is placed on the walls 130 of the first compartment 112. Once the pressure differential across the valve 16 is normalized, the valve 16 closes. Release of the compression on the flexible walls 130 of the first compartment 112 creates a new pressure differential across the valve 16 such that pressure in the second compartment 114 is greater than pressure in the first compartment 112. The valve 16 opens towards the lower pressure first compartment 112 and the liquid in the second compartment 114 enters/returns to the first compartment 112. Return of the first compartment 112 to its resting shape upon release of the compression (and also the elasticity or memory of the deformable wall 115 as will be described in more detail below) can aid in drawing the liquid back through the valve 16 into the first compartment 112. This can result in a dosing of the liquid from the second compartment 114 into the first compartment 112. Further, doses (or aliquots from the total amount of concentrate contained within the second compartment 114) can be delivered in this manner from the second compartment 114 in to the first compartment 112 as desired. The concentration within the first compartment 112 increases with each dose or aliquot delivered or each squeeze of the walls of the bottle. Users can squeeze once or twice for one or two doses of concentrate to be delivered into the first compartment 112 for a single drink. The overall volume of the second compartment 114 can allow for a plurality of doses from the second compartment 114 to be delivered to the first compartment 112, for example, 2, 3, 4, 5, 6, 7, 8, 9, 10, 11, 12 or more doses that can provide for 1, 2, 3, 4, 5, 6 or more drinks deliverable from each cartridge 117 depending on the concentration of drink desired by the user.

It should be appreciated that the cartridges described herein can be single-use, meaning, the cartridge can be disposed of after at least a portion of the concentrate is used from the cartridge for consumption of a mixed beverage. Alternatively, the cartridges described herein can be reused after at least a portion of the concentrate is used from the cartridge before being disposed of. In some implementations, the cartridges described herein can be emptied of some or most of the original amount of concentrate, filled with an additional amount of concentrate, and then used again to created one or more mixed beverages. The refillable cartridges described herein can be at least partially disassembled for cleaning and refill before being reassembled and resealed for additional usage. The refillable cartridges described herein can also be refilled without being disassembled, for example, by inserting a fill spout to fill an internal volume of the cartridge with additional amount of concentrate while the housing remains assembled. It should also be appreciated that cartridges described herein can be multi-dose cartridges such that more than a single dose of concentrate can be injected from the cartridge into a fluid for consumption. In some implementations, the multi-dose cartridges can be used to inject one or more doses into a fluid for consumption of more than one drink. By way of example only, the cartridges described herein can be filled with an amount of concentrate such that a user can deliver 1, 2, 3 or more doses of concentrate from the amount into a first volume of fluid (such as water) for consumption. Upon finishing that particular mixed drink, the same cartridge can be used again with a second volume of fluid (such as water) for consumption by delivering 1, 2, 3 or more doses of concentrate into the second volume of fluid. Again, upon finishing that particular mixed drink, the user can use the same cartridge to deliver another dose of concentrate to an additional volume of fluid for drinking until the cartridge is emptied of its contents. Although, the cartridge can be swapped out for another cartridge prior to emptying its contents. All of the cartridges described herein can be disposed of after the first, second, third or more uses. Single use cartridges include multi-dosing cartridges that are disposable. It should also be appreciated that the cartridges described herein can be configured such that their entire contents are delivered into the fluid for consumption upon a delivery of a single dose. Such cartridges can also be single-use disposable or refillable for multiple uses.

The deformable wall 115 can aid in the mixing and return of the liquid back across the valve 16 upon release of compression on walls 130. The deformable wall 115 of the second compartment 114 can stretch or otherwise expand upon receipt of the liquid in the second compartment 114. The deformable wall 115 can have a stored pressure or spring force energy that induces the flow/return of liquid from the second compartment 114 into the first compartment 112. The deformable wall 115 can be formed of a material having stretchy, elastic and/or reversible deformation properties such that the deformable wall 115 can expand to an expanded configuration upon filling of the cartridge 117 with liquid and return to a resting configuration after removal of the pressure differential. This can impart a higher pressure differential across the valve 16. The deformable wall 115 can be formed of various materials including, but not limited to various polymers, siloxane, silicone rubber, and the like. It should be appreciated that the deformable wall 115 need not be formed of a reversibly deformable material. For example, the deformable wall 115 can be formed of a plastic, metal foil, coated paper, or other material not having memory. In some implementations, the deformable wall 115 can incorporate corrugations 150 or otherwise have ridges and grooves to create additional stored energy to aid in the return of the liquid from the second compartment 114. The corrugations 150 can have any of a number of configurations, shapes and sizes and can be located across the surface of the deformable wall 115 such as shown in FIG. 13A or can be limited to a perimeter region of the deformable wall 115 as shown in FIGS. 13C-13D.

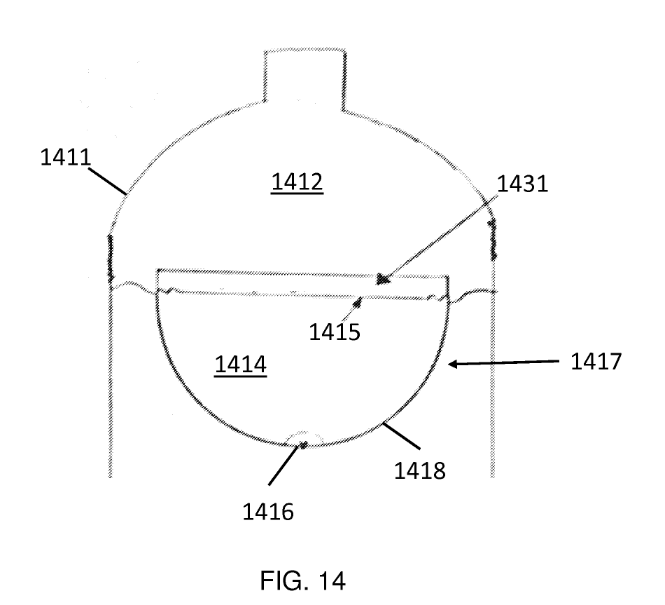

The configuration of the cartridges described herein (also referred to herein as pods) can vary. In an interrelated aspect, FIG. 14 illustrates a cartridge 1417 that can be placed into any of a variety of containers and is configured to be at least partially disassembled such that the cartridge 1417 can be refilled. The cartridge 1417 can include an air chamber 1431 separated from the concentrate chamber 1414 by a deformable wall 1415 that may be elastic and employed to store pressure energy. The housing 1418 of the concentrate chamber 1414 can have a valve 1416 positioned therein. In some implementations, the air chamber 1431 and deformable wall 1415 can be coupled to the concentrate chamber 1414 such that they can be removed from the concentrate chamber 1414 for refilling of concentrate and resealed for reuse. The cartridge 1417 can thus be self-sealing upon coupling the air chamber 1431 to the concentrate chamber 1414. The air chamber 1431 can be coupled to the housing 1418, for example, by corresponding threaded regions that can undergo, for example a ¼turn screw, or a snap-fit or other attachment mechanism such that the two portions can be reversibly attached and detached to one another. The concentrate chamber 1414 can contain an amount of concentrate that allows for each cartridge 1417 to be used for multiple servings (e.g. 14 squeezes or 6 drinks). The concentrate chamber 1414 can be single use or refillable as described herein. The cartridge 1417 can be disposed of after exhausting the amount of concentrate (i.e. single use) and replaced with another cartridge 1417. The cartridge 1417 can also be swapped out for a different cartridge 1417 at any time during use. The cartridge 1417 can also be refillable with an additional amount of concentrate as described herein. The cartridge 1417 can be configured to be coupled with the container 1411 in a variety of configurations. In some implementations, the cartridge 1417 can be coupled with the removable bottom or removable top of the container 1411 such that the valve 1416 of the cartridge 1417 is in fluid communication with the first compartment 1412 of the container 1411. Alternatively, the cartridge 1417 can be integrated with at least a portion of the container 1411.

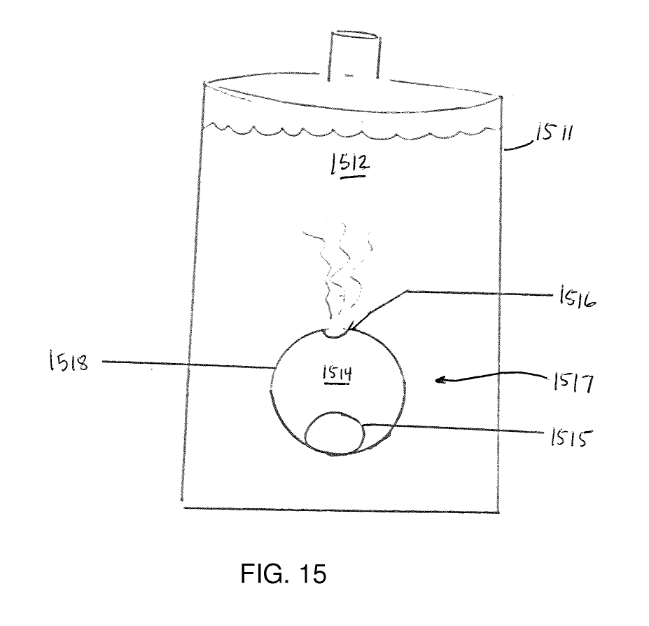

In an interrelated aspect, FIG. 15 illustrates a cartridge 1517 that can be a free-floating pod for use with any type of container 1511. The cartridge 1517 can have a concentrate container housing 1518 that can be a rigid shell having a soft air bladder 1515 positioned therein and a valve 1516. Upon squeezing the walls of the container 1511, the air bladder 1515 can be compressed such that fluid from the first compartment 1512 can be injected through the valve 1516 into the second compartment 1514 formed by the housing 1518. After the user stops squeezing the walls of the container 1511, the air bladder 1515 can return to its original size to aid in ejecting the fluid, now mixed with concentrate from the second compartment 1514, back out the valve 1516 into the first compartment 1512 for a user to consume. In some implementations, the volume of the air bladder 1514 can be approximately ¼ to ⅕ of the volume of second compartment 1514. The valve 1516 can be a dripless two way valve as described elsewhere herein. The housing 1518 can be refillable for example by including a plug or other removable feature that can be reversibly coupled to at least a portion of the housing 1518. In some implementations, the cartridge 1517 can be formed of two portions that can be snap-fit or threaded together as described herein such that additional concentrate can be added to the concentrate chamber 1514 of the housing 1518. The cartridge 1517 can have a variety of shapes, for example, a sphere as shown in FIG. 15 or other geometric shape. As with other implementations described herein the cartridge 1517 can be refillable and reusable or disposable. The cartridge 1517 can be used to deliver multiple doses of concentrate into the first compartment 1512 such that a single cartridge 1517 filled with an amount of concentrate can be used to inject multiple doses of concentrate into the first compartment 1712 such that multiple drinks can be made with a single fill of a cartridge 1717.

It should be appreciated that use of the term “concentrate,” “concentrate chamber” or “concentrate compartment” are not intended to be limiting to any particular type of material (liquid, powder, gel, solid, etc.). Rather, concentrate as used herein generally refers to the material contained within the cartridge that is intended to be mixed with a fluid in the drinking container before being consumed by a user.

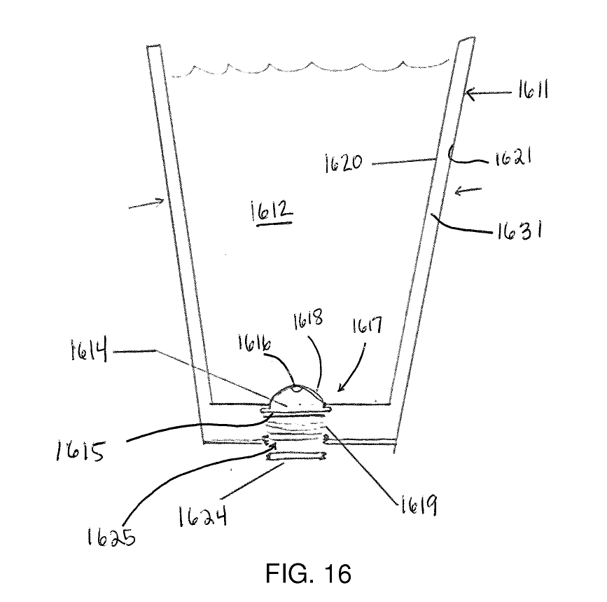

It should be appreciated that the cartridges and pods described herein can be configured such that they can be used with closed volume containers as described above as well as with open containers. For example, FIG. 16 illustrates an interrelated implementation of a cartridge 1617 configured to be used with an open container 1611 such as an insulated cup. The open container 1611 can have a dual wall formed by a rigid inner wall 1620 surrounded by an elastic outer wall 1621 and having an inner air chamber 1631 therebetween. The cartridge 1617 can include a two way valve 1616 positioned within an aperture of the housing 1618. At least a portion of the housing 1618 is configured to extend through an opening in the rigid inner wall 1620 of the container 1611 such that the valve 1616 is in fluid communication with the liquid held within the first compartment 1612 of the container 1611. The cartridge 1617 can include a deformable wall or membrane 1615 that seals the housing 1618 against a surface of the inner wall 1620 surrounding the opening. The deformable membrane 1615 may be elastic and employed to store pressure energy. The cartridge 1617 can also include a spacer element 1619 such as a spring and a seal 1624. The seal 1624 can be removable plug or other feature that can be reversibly coupled with the outer wall 1621, such as by threading the seal 1624 into a corresponding slot 1625 in the outer wall 1621, to seal the inner air chamber 1631 between the inner wall 6120 and outer wall 1621 as well as urge the spacer element 1619 upwards to press the outer perimeter or flange surrounding the membrane 1615 against the surface of the inner wall 1620 surrounding the opening that can form a water tight seal upon coupling the seal 1624 within the slot 1625 of the outer wall 1621. The cartridge 1617 is shown partially exploded with the seal 1624 shown separated from the slot 1625. The spacer element 1619 can be an open architecture element such as a spring that allows for fluid communication between the air chamber 1631 and the lower surface of the membrane 1615. Upon compression of the elastic outer wall 1621 toward the inner wall 1620 (arrows in FIG. 16), increased pressure in the air chamber 1631 increases the pressure applied against the lower surface of the membrane 1615 causing the membrane 1615 to move up into the second compartment 1614 of the housing 1618 such that a shot of concentrate held within the housing 1618 is ejected out through the valve 1616 into the first compartment 1612 of the container 1611. Upon release of compression on the outer wall 1621, an amount of the liquid within the cup 1611 can be sucked back through the valve 1616 into the housing 1618 to mix with the concentrate in the second compartment 1614. As with other implementations described herein the cartridge 1617 can be refillable and reusable or disposable. The cartridge 1617 can be used to deliver multiple doses of concentrate into the first compartment 1612 such that a single cartridge 1617 filled with an amount of concentrate can be used to inject multiple doses of concentrate into the first compartment 1612 such that multiple drinks can be made with a single fill of a cartridge 1617.

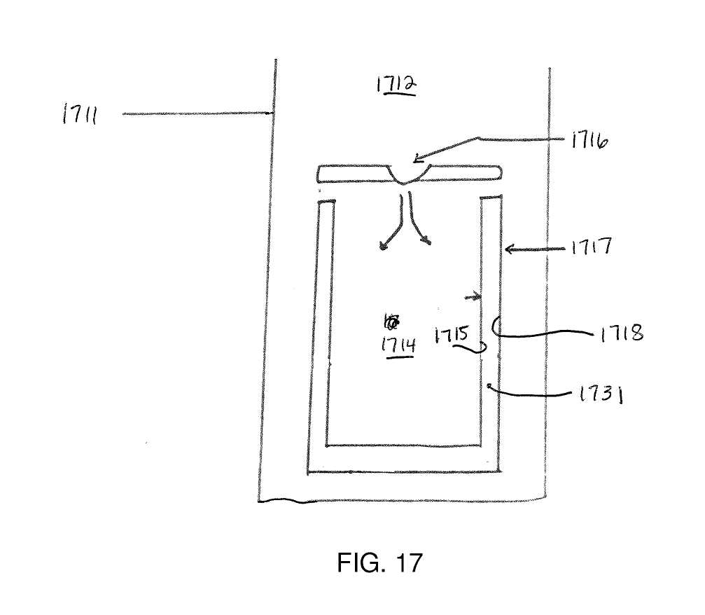

In an interrelated aspect, FIG. 17 illustrates a cartridge 1717 having a dual wall formed by an inner wall 1715 surrounded by an outer wall 1718 and having an inner air chamber 1731 therebetween. The cartridge 1717 can include a two way valve 1716 positioned within an aperture through the walls 1715, 1718 of the cartridge 1717. The inner wall 1715 can be soft and elastic whereas the outer wall 1718 can be hard or otherwise rigid. The cartridge 1717 can be positioned within a first compartment 1712 of a soft-walled container 1711 configured to hold water or other fluid a user wants to mix with the concentrate within the second compartment 1714 of the cartridge 1717. Upon squeezing the walls of the container 1711, fluid from the first compartment 1712 is forced into the second compartment 1714 of the cartridge 1717 through the valve 1716. The increased fluid pressure inside the second compartment 1714 causes compression of the soft inner wall 1715 of the cartridge 1717. Once compression on the soft walls of the container 1711 is released, the inner wall 1715 of the cartridge 1717 can return to its first shape ejecting a dose of concentrate back through the valve 1716 into the first compartment 1712. As with other implementations described herein the cartridge 1717 can be refillable and reusable or disposable. The cartridge 1717 can be used to deliver multiple doses of concentrate into the first compartment 1712 such that a single cartridge 1717 filled with an amount of concentrate can be used to inject multiple doses of concentrate into the first compartment 1712 such that multiple drinks can be made with a single fill of a cartridge 1717.

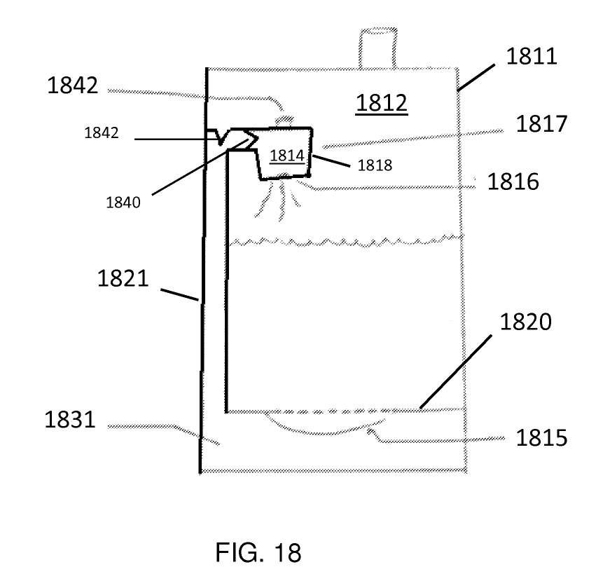

In an interrelated aspect, FIG. 18 illustrates a cartridge 1817 that can include a concentrate plug or fill spout 1842, a valve 1816, such as a two-way valve, for delivery of concentrate from a concentrate compartment 1814 of the cartridge 1817 into a first compartment 1812 of the container 1811. The cartridge 1817 can be coupled via a check valve 1840 to a container 1811 having an inner wall 1820 surrounded at least in part by an outer wall 1821 forming an inner air chamber 1831 therebetween. The check valve 1840 can be positioned between the concentrate compartment 1814 of the cartridge 1817 and the inner air chamber 1831 of the container 1811. A dose of concentrate can be delivered from the cartridge 1817 into the first compartment 1812 of the container 1811 by squeezing at least a portion of the container 1811. An elastic membrane 1815 coupled to at least a portion of the inner wall 1820 can deflect or flex inward into the inner air chamber 1831 thereby increasing the pressure within the inner air chamber 1831. This increase in pressure within the inner air chamber 1831 is transmitted through the check valve 1840 into the concentrate compartment 1814 of the cartridge 1817 thereby causing an amount of concentrate to be ejected through the valve 1816 and into the first compartment 1812. Thus, fluid from the first compartment 1812 does not enter the concentrate compartment 1814. This can avoid diluting and contaminating the concentrate within the second compartment 1814 with fluid from the first compartment 1812 providing more accurate dosing as well as prolonging the life of the concentrate within the cartridge due to spoilage. Upon release of the walls of the container 1811, the membrane 1815 returns to its resting position and the inner air chamber 1831 fills back up with air. In some implementations, a second check valve 1841, such as a duckbill valve or similar valve, can be incorporated to allow for air to be sucked back into the inner air chamber 1831 although it should be appreciated that other configurations for refilling the inner air chamber 1831 are considered herein. As with other implementations described herein the cartridge 1817 can be refillable, such as through the fill spout 1842, and reusable or disposable. The cartridge 1817 may be a single-use disposable cartridge that provides multiple doses, but is disposed after use. The cartridge 1817 can be used to deliver multiple doses of concentrate into the first compartment 1812 such that a single cartridge 1817 filled with an amount of concentrate can be used to inject multiple doses of concentrate into the first compartment 1812 such that multiple drinks can be made with a single fill of a cartridge 1817.

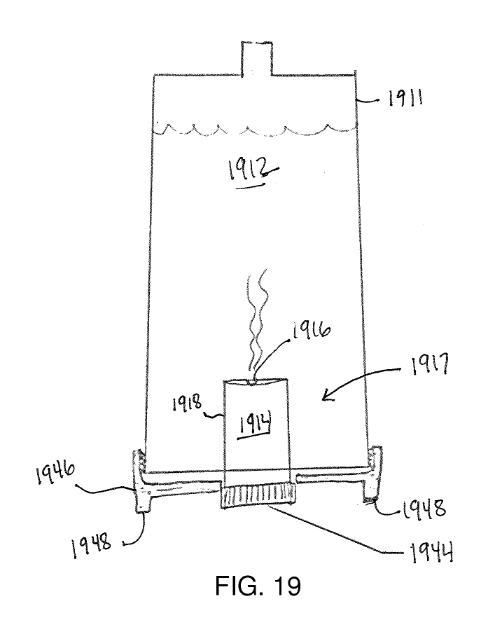

In an interrelated aspect, FIG. 19 illustrates an additional implementation of a refillable cartridge 1917. The cartridge 1917 can include a housing 1918 having a valve 1916 positioned within an aperture of the housing 1918 and configured to be in fluid communication with a first compartment 1912 of a container 1911 such as a soft-walled sports bottle. The cartridge 1917 can include a removable cap 1944 for sealing engagement with the housing 1918 of the cartridge 1917. The removable cap 1944 can include threads to engage corresponding threads on at least an end of the housing 1918, although it should be appreciated that any of a variety of engagement mechanisms between the removable cap 1944 and the housing 1918 are considered herein. The removable cap 1944 can be available on the bottom end of the container 1911 such that it can be removed (e.g. unscrewed) for refilling with concentrate while the first compartment 1912 of the container 1911 is filled with fluid. The removable cap 1944 can have gripping features that allow for tightening or loosening of the removable cap 1944. It should be appreciated that the removable cap 1944 may have other latching features besides threads, such as snap fit features etc. The removable cap 1944 can extend through a stand 1946 having a protrusion or foot 1948 configured to engage an end of the container 1911. In some implementations, the bottom lid of the container 1911 and the stand 1946 are integrated. The foot 1948 can extend beyond the removable cap 1944 such that an even surface is created for the bottom of the container 1911 for stability such that the container 1911 can be stood up without the removable cap 1944 affecting the balance of the container 1911. The foot 1948 can include two or three or four or more protrusions extending from the removable bottom. The foot 1948 can also include a flange encircling the removable bottom such that a user can still grip the removable cap 1944 of the cartridge 1917 without the foot 1948 getting in the way. The refillable cartridge 1917 can have a concentrate compartment 1914 configured to be filled with concentrate by removing the removable cap 1944 without needing to remove the bottom lid of the container 1911. As with other implementations described herein the cartridge 1917 can be refillable and reusable or disposable. The cartridge 1917 can be used to deliver multiple doses of concentrate into the first compartment 1912 such that a single cartridge 1917 filled with an amount of concentrate can be used to inject multiple doses of concentrate into the first compartment 1912 such that multiple drinks can be made with a single fill of a cartridge 1917.

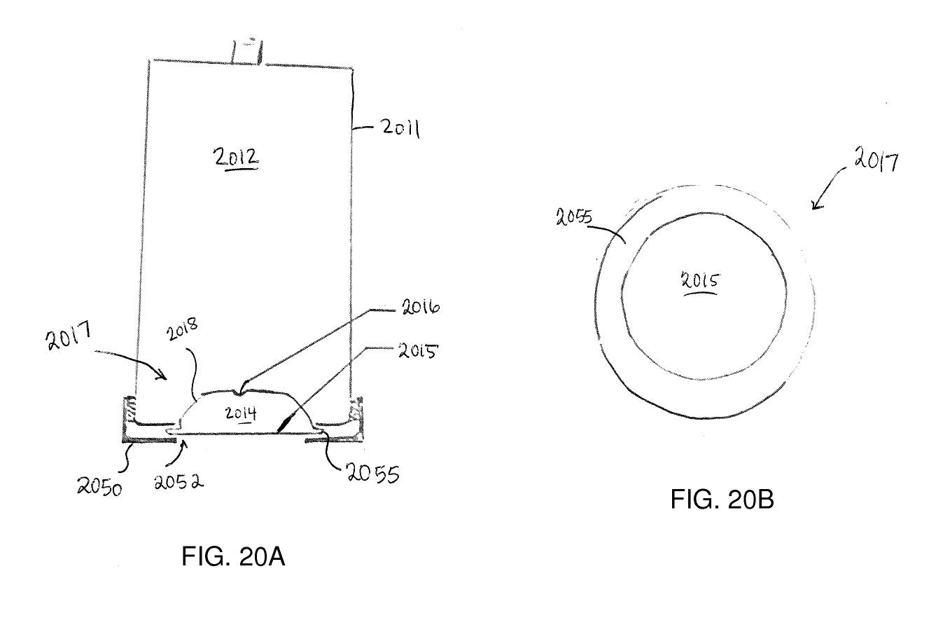

The cartridges described herein need not be used only with soft-walled containers such as flexible plastic sport bottles. In an interrelated aspect, FIG. 20A illustrates an implementation of a cartridge 2017 that can be used with a rigid walled container 2011. The cartridge 2017 can include a housing 2018 having a valve 2016 positioned within an aperture of the housing 2018. The housing 2018 is sealed on an opposite end by a deformable membrane 2015 forming a second compartment 2014 within which concentrate can be contained. The deformable membrane 2015 may be elastic and employed to store pressure energy. At least a portion of the housing 2018 and the valve 2016 of the cartridge 2017 can extend through an opening in the bottom of the container 2011 such that the valve 2016 is in fluid communication with a first compartment 2012 of the container 2011. The cartridge 2017 can be held in position within the opening by a removable bottom 2050 of the container 2011. The removable bottom 2050 can be threaded onto an end of the container 2011 until the removable bottom 2050 presses against and captures a flange 2055 around the lower perimeter of the cartridge 2017 against a lower end of the walls of the container 2011 (see bottom view of the cartridge 2017 in FIG. 20B). The removable bottom 2050 of the container 2011 can include an opening 2052 through which a lower surface of the deformable membrane 2015 is available from the outside such that a user can manually press on the lower surface of the deformable member 2015 (such as with a finger or thumb) to eject an amount of concentration from within the second compartment 2014 into the first compartment 2012. As with other implementations described herein the cartridge 2017 can be refillable and reusable or disposable. The cartridge 2017 can be used to deliver multiple doses of concentrate into the first compartment 2012 such that a single cartridge 2017 filled with an amount of concentrate can be used to inject multiple doses of concentrate into the first compartment 2012 such that multiple drinks can be made with a single fill of a cartridge 2017.

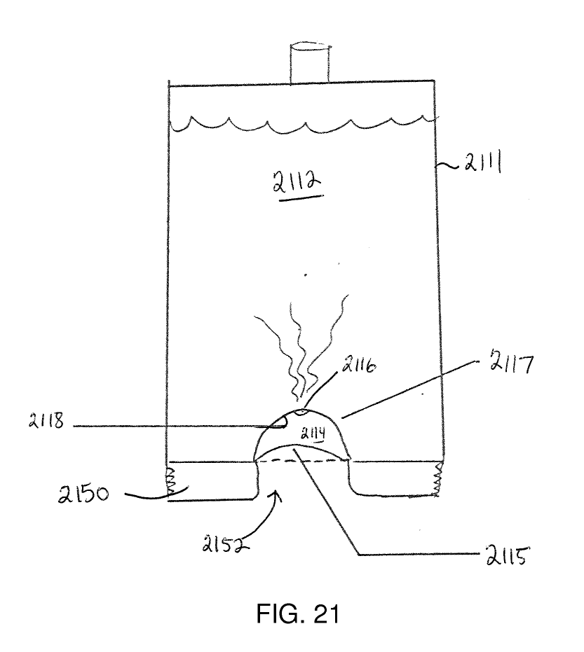

FIG. 21 illustrates an interrelated implementation of a manually actuatable cartridge 2117 in which a deformable membrane 2115 of the cartridge 2117 aligns with an opening 2152 extending through a removable bottom 2150 of the container 2111. A user can insert a finger or thumb through the opening 2152 to contact the membrane 2115 to dispense concentrate from the second compartment 2114 of the cartridge 2117 through the valve 2116 in the housing 2118 and into the first compartment 2112 of the container 2111. This configuration of cartridge 2117 is particularly useful with a rigid walled container 2111 made of a harder plastic, glass, or metal. As with other implementations described herein the cartridge 2117 can be refillable and reusable or disposable. The cartridge 2117 can be used to deliver multiple doses of concentrate into the first compartment 2112 such that a single cartridge 2117 filled with an amount of concentrate can be used to inject multiple doses of concentrate into the first compartment 2112 such that multiple drinks can be made with a single fill of a cartridge 2117.

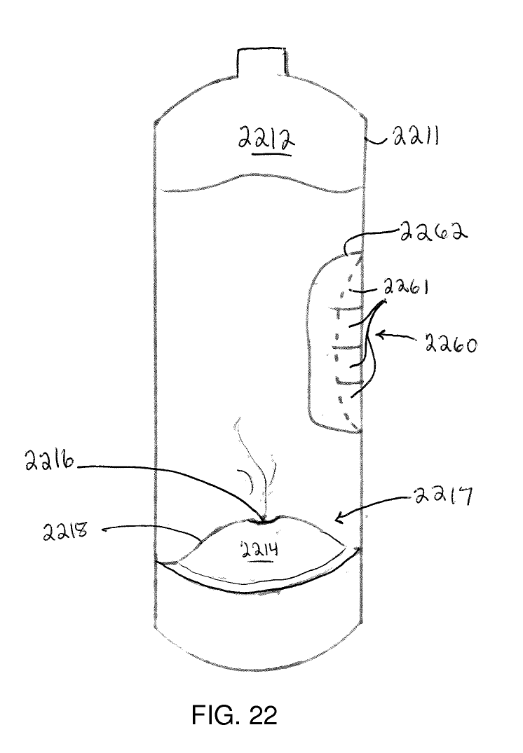

In an interrelated aspect, FIG. 22 illustrates an implementation of a cartridge 2217 for use with a container 2211 having one or more pressure pads 2260 positioned within one or more windows 2262 in a wall of the container 2211. The pressure pad 2260 can be located on any of a variety of locations on the container 2211. In one implementations, the pressure pad 2260 is located on a side wall of the container 2211 such as where a user might grip the container 2211 for drinking from a spout on an upper end of the container 2211. The walls of the container 2211 can be generally rigid (e.g. metal, glass, hard plastic) whereas the material of the pressure pad 2260 can be deformable. The outer surface of the pressure pad 2260 can be pressed by a user causing the deformable material of the pressure pad 2260 to extend inwards toward the first compartment 2212 of the container 2211. The pressure inside the first compartment 2212 of the container 2211 can increase causing fluid within the first compartment 2212 to be forced through a valve 2216 in the housing 2218 of the cartridge 2217 into the second compartment 2214. Upon release of the pressure pad 2260 an amount of concentrate from inside the second compartment 2214 of the cartridge 2217 is ejected back out through the valve 2216 into the first compartment 2212 as described elsewhere herein. The pressure pad 2260 can be metered such that just the right amount of concentrate is activated according to a user's taste. For example, the pressure pad 2260 can be divided into one, two, three, four or more separately actuatable buttons 2261. The pressure within the first compartment 2212 increases to a particular amount upon pressing one or more of the buttons 2261 resulting in a corresponding amount of concentration that gets dispensed from the cartridge 2217. By way of example only, if a greater amount of concentrate is desired for a stronger flavored drink, a user can click three of four buttons 2261 of the pressure pad 2260. If a lesser amount of concentrate is desired for making a weaker flavored drink, a user can click only one of the four buttons 2261 on the pressure pad 2260. As with other implementations described herein the cartridge 2217 can be refillable and reusable or disposable. The cartridge 2217 can be used to deliver multiple doses of concentrate into the first compartment 2212 such that a single cartridge 2217 filled with an amount of concentrate can be used to inject multiple doses of concentrate into the first compartment 2212 such that multiple drinks can be made with a single fill of a cartridge 2217.

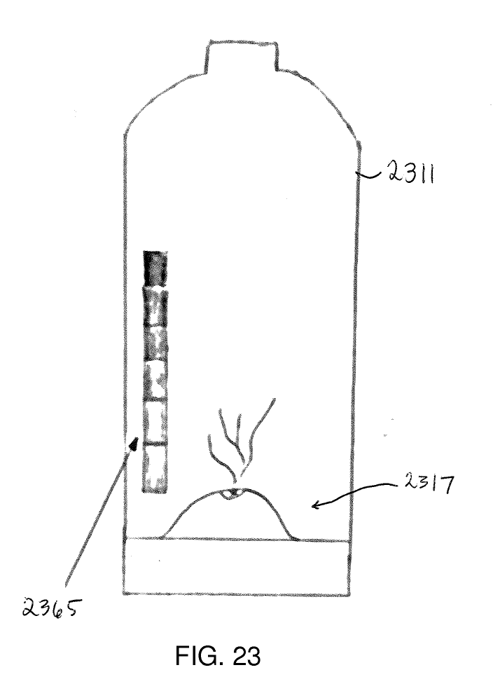

In an interrelated aspect, FIG. 23 illustrates a potency chart 2365 positioned on an outer surface of a container 2311. The potency chart 2365 can be used with cartridges 2317 containing colored concentrates. Mixing of an amount of some colored concentrates from the cartridge 2317 with the fluid in the container 2311 can result in a particular flavor potency and also a particular color level. The potency chart 2365 can include several gradations of color indicative of the potency. The color level within the container 2311 can be visible through at least a portion of the wall of the container 2311 near the potency chart 2365 such that a relative visual comparison can be made between the fluid inside the container 2311 and the potency chart 2365 color gradations allowing a user to achieve their perfect level of potency for every drink made with the cartridge 2311. The walls of the container 2311 can be clear plastic or glass or have at least a portion that is clear such that the true color of the fluid inside is visible from the outside.

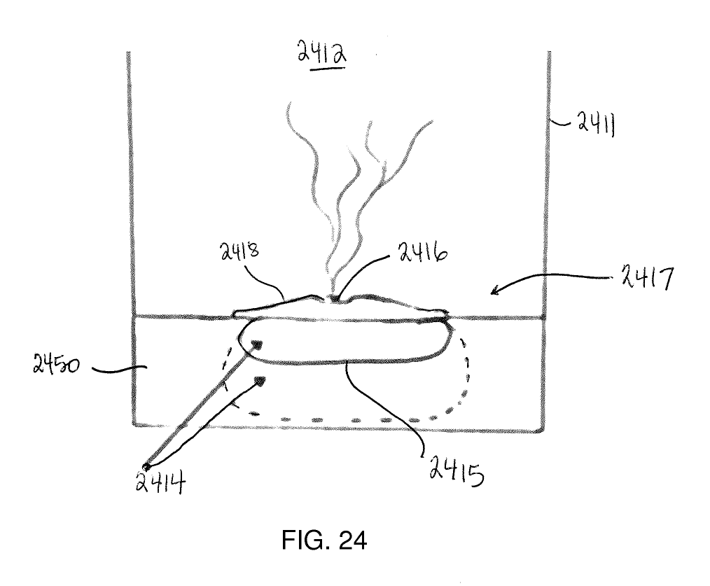

In an interrelated aspect, FIG. 24 illustrates a cartridge 2417 having a rigid housing portion 2418 and a flexible housing portion 2415. The rigid housing portion 2418 can have an aperture extending through it within which a valve 2416, such as a two-way valve, can be positioned. The rigid housing portion 2418 and the valve 2416 can be positioned relative to the container 2411 for example through an opening near a bottom end of the container 2411 such that the valve 2416 is maintained in fluid communication with the first compartment 2412 of the container 2411. The flexible housing portion 2415 can be located external to the first compartment 2412. The flexible housing portion 2415 can be positioned, for example, within a protective compartment 2450 forming an air chamber within the container. The flexible housing portion 2415 can expand such as upon filling with concentrate. The flexible housing 2415 can also be elastic or stretchy such that even when filled with concentrate it can receive an amount of fluid injected through the valve 2416 from the first compartment 2412 and then return to its original shape injecting a dose of concentrate back out through the valve 2416. Thus, the flexible housing portion 2415 can function as both a housing for the concentrate compartment 2414 and deformable wall as described elsewhere herein. As with other implementations described herein, the cartridge 2417 can be refillable such as by separating the rigid housing portion 2418 from the flexible housing portion 2415. The flexible housing portion 2415 can be coupled to the protective compartment 2450 that, in turn, can be removable from the container 2411. For example, a user can remove the protective compartment 2450 within which the flexible housing portion 2415 is coupled from the bottom end of the container 2411 in order to fill the flexible housing portion 2415 with concentrate and then reattach the protective compartment 2450 to the container 2411 and thus, the flexible housing portion 2415 to the rigid housing portion 2418. The mechanisms by which the two housing portions 2415, 2418 mate can vary, for example, with a snap-fit attachment, interference fit, corresponding threaded regions and the like. As with other implementations described herein the cartridge 2417 can be refillable and reusable or disposable. The cartridge 2417 can be used to deliver multiple doses of concentrate into the first compartment 2412 such that a single cartridge 2417 filled with an amount of concentrate can be used to inject multiple doses of concentrate into the first compartment 2412 such that multiple drinks can be made with a single fill of a cartridge 2417.

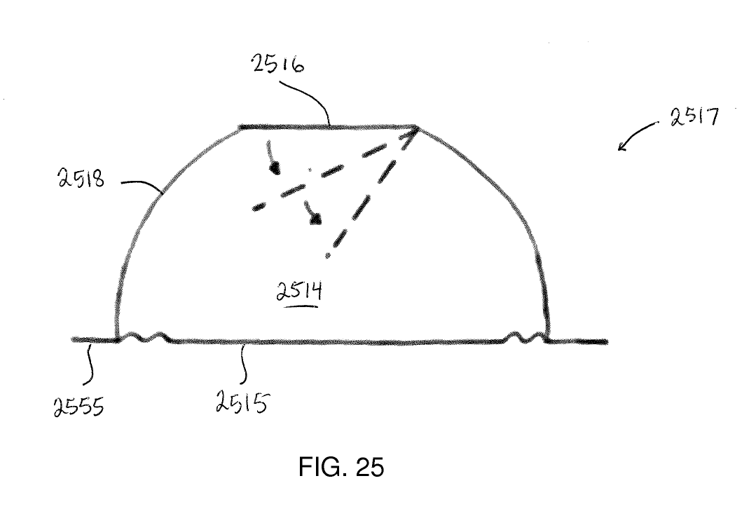

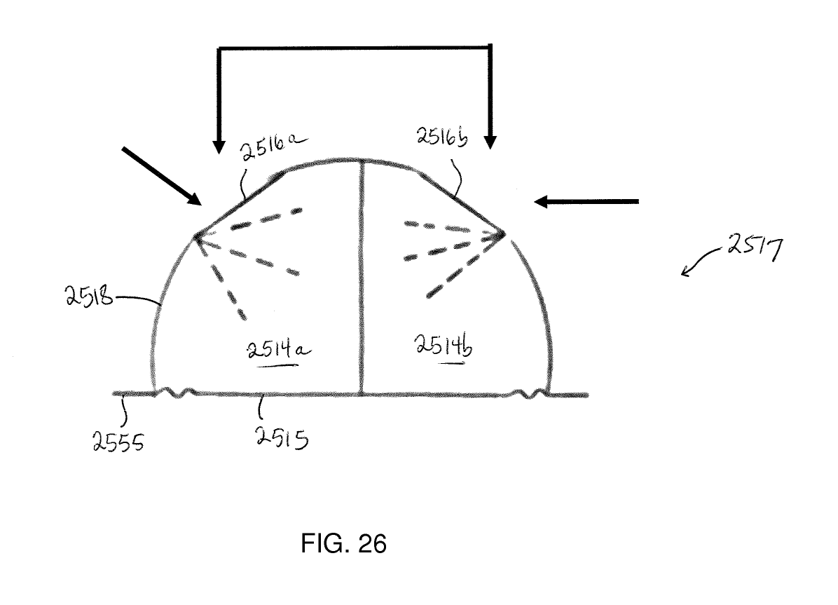

In an interrelated aspect, FIGS. 25 and 26 illustrate implementations of a cartridge 2517 for use with a concentrate that may not be effectively deliverable through a valve, for example, powders, meal replacements, infant formula or similar substances. The cartridge 2517 can include a housing 2518 having a deformable wall 2515 and a window 2516 that can be opened to create a larger, free flowing port through which a concentrate within the second compartment 2514 can be delivered into a first compartment of a container. The cartridge 2517 can also include a flange 2555 or other surface feature configured to interface with at least a portion of a container as described elsewhere herein. In some implementations, the window 2516 is an opening in the housing 2518 that is covered by a foil top or similar material configured to give way relative to the housing 2518 upon application of pressure from outside the cartridge 2517. In other implementations, the window 2516 is a partially perforated region in the housing 2518 configured to break away relative to the surrounding region of the housing 2518 upon application of pressure from outside the cartridge 2517. The window 2516 of the cartridge 2517 can be a single-use type of opening that breaks open upon application of pressure and cannot be resealed. The window 2516 can also be resealable such that the cartridge 2517 can be refilled and reused. For example, the window 2516 can be closed with a snap-fit type hinge feature that can release and open up upon application of pressure and also be returned to its original seated or closed position with the housing 2518. The size of the window 2516 allows for a larger volume to be delivered. For example, the window 2516 can be positioned with a container such that the window 2516 remains in fluid communication with a first compartment of the container and the flange is held for example by capturing with a screw-on lid or bottom. A single squeeze on a flexible outer wall of the container (e.g. a flexible plastic bottle) can increase pressure on the outer surface of the window 2516 until it breaks open and the first and second compartments can be fully mixed together (e.g. via shaking). It should be appreciated that the first compartment of the container can hold a fluid and be used for drinking without opening the window 2516 to release the concentrate into the first compartment. For example, the first compartment of the container can be filled with water and the cartridge 2517 can be pre-loaded with protein powder in the second compartment. A user can drink the water from the first compartment, for example during a workout, and then actuate the preloaded protein powder from the cartridge 2517 to be mixed with water in the first compartment, for example at the end of the workout.

FIG. 26 shows an interrelated implementation of a cartridge 2517 that is multi-chambered for the delivery of two, three, four or more separated components. The cartridge 2517 can have a housing 2518 having a concentrate compartment 2514 split into a first chamber 2514a and a second chamber 2514b each having their respective windows 2516a, 2516b. The various chambers can include windows that are configured to all give way in a stepped pressure manner. Each chamber 2514a, 2514b can open at a different pressure such that the chambers 2514a, 2514b are separately actuatable. For example, first chamber 2514a can have a window 2516a that opens upon application of 5 lbs of pressure (or other pressure) and second chamber 2514b can have a window 2516b that opens upon application of 20 lbs of pressure (or other pressure). The first and second chambers 2514a, 2514b can be used to hold any of a variety of materials, for example, one or more of pre-workout, workout, post-workout, meal replacements, water purification, infant formulas, etc. It should be appreciated that the pressure applied to open the windows can vary. Generally, the pressure required to open the windows should be high enough so as not to inadvertently release materials within the chamber, but not so high that breaking open the seal of the window is too difficult.

While this specification contains many specifics, these should not be construed as limitations on the scope of what is claimed or of what may be claimed, but rather as descriptions of features specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results. Only a few examples and implementations are disclosed. Variations, modifications and enhancements to the described examples and implementations and other implementations may be made based on what is disclosed.

1. A cartridge for use with a drinking container having a fluid compartment, the cartridge comprising:
a concentrate compartment adapted for storage of a concentrate;
a housing at least partially defining the concentrate compartment;
a deformable wall coupled to the housing and at least partially defining the concentrate compartment;
a valve coupled to the housing; and
an air chamber separated from the concentrate compartment by the deformable wall,
wherein the cartridge is actuatable to inject sequential doses of the concentrate into a fluid compartment through the valve.

2. The cartridge of claim 1, further comprising the drinking container having the fluid compartment.

3. The cartridge of claim 2, wherein the valve is configured to provide fluid communication between the concentrate compartment and the fluid compartment of the drinking container when the cartridge is in use with the drinking container.

4. The cartridge of claim 1, wherein the cartridge is configured as at least one of a disposable, single use cartridge or a refilled cartridge configured to allow insertion of an additional amount of concentrate in the concentrate compartment.

5. The cartridge of claim 4, wherein the cartridge is configured to be partially disassembled such that the concentrate compartment is refilled with the additional amount of concentrate.

6. The cartridge of claim 5, wherein the deformable wall is removably coupled to the housing.

7. The cartridge of claim 6, wherein the deformable wall is coupled to a lid configured to be removably coupled to the housing.

8. The cartridge of claim 7, wherein the air chamber is located within the removable lid.

9. The cartridge of claim 1, wherein the deformable wall is configured to store pressure energy.

10. The cartridge of claim 9, wherein the deformable wall aids in injecting the sequential doses of the concentrate through the valve.

11. The cartridge of claim 9, wherein the deformable wall is an elastic membrane formed of at least one of a polymer, a siloxane, or a silicone rubber.

12. The cartridge of claim 9, wherein the deformable wall comprises corrugations creating additional stored energy.

13. The cartridge of claim 12, wherein the corrugations are located near a perimeter of the deformable wall.

14. The cartridge of claim 2, wherein increased pressure within the fluid compartment causes a volume of fluid from the fluid compartment to enter the concentrate compartment through the valve.

15. The cartridge of claim 14, wherein the deformable wall deflects towards the air chamber upon receipt of the volume of fluid from the fluid compartment and wherein upon removal of the increased pressure within the fluid compartment the deformable wall returns to its original position injecting a dose of the concentrate into the fluid compartment through the valve.

16. (canceled)

17. The cartridge of claim 1, wherein the concentrate compartment has a volume sufficient to inject sequential doses sufficient to create a plurality of different mixed beverages, wherein the plurality of mixed beverages is 2, 3, 4, 5, or 6 different mixed beverages.

18. (canceled)

19. The cartridge of claim 2, wherein the drinking container comprises a lid removably coupled to a first end of the drinking container and a bottom removably coupled to a second end of the drinking container to sealingly contain the fluid compartment.

20. The cartridge of claim 19, wherein the cartridge is maintained in sealed engagement with the drinking container between the bottom and the second end of the drinking container upon threading the bottom onto the second end of the drinking container.

21. The cartridge of claim 20, further comprising an o-ring configured to form a fluid-tight seal between the bottom and the second end of the drinking container.

22. The cartridge of claim 21, wherein the cartridge comprises a flange around a perimeter configured to be captured between the o-ring and the second end of the drinking container such that the deformable wall extends across a recess of the removable bottom.

23-25. (canceled)

26. The cartridge of claim 1, wherein the deformable wall is located opposite the valve.

27. The cartridge of claim 2, wherein at least a portion of the fluid compartment of the drinking container is flexible.

28. The cartridge of claim 27, wherein compression of the portion of the fluid compartment causes fluid contained within the fluid compartment to enter the concentrate compartment through the valve and wherein release of the compression injects a dose of the concentrate from the concentrate compartment through the valve and into the fluid compartment.

29-82. (canceled)
